(19) United States
(12) Patent Application Publication
(10) Pub. No.: US 2013/0150257 A1
(43) Pub. Date: Jun. 13, 2013

(54) METHODS AND COMPOSITIONS FOR SAMPLE IDENTIFICATION

(71) Applicant: Veracyte, Inc., South San Francisco, CA (US)

(72) Inventors: Diana Abdueva, Orinda, CA (US); Giulia C. Kennedy, San Francisco, CA (US); P. Sean Walsh, Danville, CA (US)

(73) Assignee: Veracyte, Inc., South San Francisco, CA (US)

(21) Appl. No.: 13/710,134

(22) Filed: Dec. 10, 2012

Related U.S. Application Data
(60) Provisional application No. 61/630,373, filed on Dec. 10, 2011.

(51) Int. Cl. G06F 19/20; G06F 19/24

(52) U.S. Cl. CPC G06F 19/20; G06F 19/24
USPC 506/9; 435/6.11; 435/6.12; 435/6.1; 702/19

(57) ABSTRACT

Compositions and methods are provided to provide an expression signature for a sample, where an alternative splicing index and profile are determined for the sample based on variations in the splicing of messenger RNA for at least one gene in the sample.

### CROSS-REFERENCE

This application claims benefit of U.S. Provisional Patent Application No. 61/630,373, entitled “Methods and Compositions for Sample Identification,” filed Dec. 10, 2011, incorporated herein by reference in its entirety.

### BACKGROUND OF THE INVENTION

Molecular analysis of even a single biological sample can be a multi-step process and can result in the generation of numerous sample intermediates. An example is expression analysis of samples, e.g., clinical samples. Expression data from samples may be used to determine a “sample fingerprint” based on alternative splicing index that may be used in a variety of ways.

### SUMMARY OF THE INVENTION

In one aspect, a method of establishing a sample mRNA signature is described herein, the method comprising: assaying a biological sample to obtain a set of gene expression data for the biological sample; determining an alternative splicing index (ASI) for a gene in the set of gene expression data; and establishing an alternative splicing profile for the sample using the alternative splicing index, thereby establishing the sample mRNA signature of the biological sample.

In some embodiments, the set of gene expression data contains expression data for at least two genes and the ASI is determined using the data for the at least two genes. In some embodiments, each of the at least two genes comprises a plurality of exons. In some embodiments, each of the at least two genes comprises at least three exons. In some embodiments, each of the at least two genes comprises at least six exons. In some embodiments, each of the at least two genes is a gene with an expression level that has a signal strength that is above a threshold value. In some embodiments, the threshold value is 6 in log 2 units of intensity. In some embodiments, each of the at least two genes is a gene that corresponds to exons that have a multimodal distribution of expression. In some embodiments, the multimodal distribution of expression is determined using Hartigan's dip test of unimodality with a cut off set at greater than 0.05.

In some instances, the biological sample is assayed by microarray, serial analysis of gene expression (SAGE), blotting, RT-PCR, sequencing, or quantitative PCR.

In some instances, the ASI is calculated using the equation: log(e_{i,j,k})−log(g_{j,k}), wherein e_{i,j,k} equals an exon signal for i^{th} probeset, k tissue, j gene; and g_{j,k} equals a transcript signal for k tissue and j gene.

In another aspect, a method of relating a biological sample to a plurality of biological samples is described herein, wherein the plurality of biological samples are obtained from a subject, the method comprising: establishing an alternative splicing profile using a set of gene expression data for the biological sample and each of the plurality of biological samples; relating the alternative splicing profiles of the biological sample and the plurality of biological samples using a computer; and identifying whether the biological sample is from the same subject of the plurality of biological samples.

In some embodiments, the set of gene expression data contains expression data of one or more genes. In some embodiments, the alternative splicing profile is related by performing a correlation analysis. In some embodiments, the biological sample is assayed by microarray, serial analysis of gene expression (SAGE), blotting, RT-PCR, sequencing, or quantitative PCR.

In some instances, the ASI is calculated using the equation: log(ei,j,k)−log(gj,k), wherein ei,j,k equals an exon signal for ith probeset, k tissue, j gene; gj,k equals a transcript signal for k tissue and j gene.

In some instances, each of the one or more genes meets at least one requirement selected from the group consisting of: a gene that contains a plurality of exons, a gene with an expression level that has a signal strength that is above a threshold value, and a gene that corresponds to exons that have a multimodal distribution of expression. In some embodiments, the sample is identified as from the same subject as the plurality of samples. In some embodiments, the sample is identified as not from the same subject as the plurality of biological samples. In some embodiments, the sample and the plurality of samples belong to a pool of samples, and the sample that has been identified as not from the same subject as the plurality of samples is removed from the pool of samples. In some embodiments, the alternative splicing profile is established by calculating the alternative splicing index (ASI) of each of the one or more genes.

In some instances, the correlation analysis is performed by: defining for each of the plurality of biological samples a within-group cohort and an outside-group cohort, wherein the within-group cohort contains all of the plurality of biological samples that belong to the same subject, and wherein the outside-group cohort contains all of the plurality of biological samples that belong to a different subject; subsequent to defining the within-group cohort for each of the plurality of biological samples, producing a median within-group correlation score for each of the plurality of biological samples, wherein the median within-group correlation score is calculated using the alternative splicing profile of each of the biological samples that in the within-group cohort; subsequent to defining the outside-group cohort for each of the plurality of biological samples, producing a maximum outside-group correlation score for each of the plurality of biological samples, wherein the maximum outside-group correlation score is calculated using the alternative splicing profile of each of the biological samples in the outside-group cohort; and comparing the median within-group correlation score and the maximum outside-group correlation score for each of the plurality of biological samples, thereby performing correlation analysis.

In some instances, the plurality of biological samples are from thyroid tissue.

In one aspect, a machine-readable medium in a tangible physical form is disclosed that is either portable or associated with a computer, on which one or more computer-executable instructions are contained for performing an analysis to relate a biological sample to a plurality of biological samples, wherein the biological sample is related to the plurality of biological sample using an alternative splicing profile of the biological sample and each of the plurality of biological samples.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 (A-C) illustrates an Alternative Splicing case study of gene CYP4F11. Panel 1A, expression signal vs. genomic position of all exons in transcript. Panel 1B, expression signal vs. genomic position of exons 1-4. Note that approximately half the samples in the cohort express exon 2, while the other half lack expression of this exon. Panel 1C, alternative splicing index per sample in entire cohort (n=68). Note that the calculated alternative splicing index using only a single transcript suggests that at least one sample from two patients (arrows; 131 & 141) was incongruent with the alternative splicing index of other samples from the same patient.

FIG. 2 (A-C) illustrates black and white representation of a tri-color heatmaps that illustrate that Alternative Splicing Index correlation heatmaps can improve after selective filtering. Panel 2A, examining genes that have 6 or more exons per transcript. Panel 2B, examining genes that have 6 or more exons per transcript and filtering out transcripts with low signal (≦6, log₂ space). Panel 2C, examining genes that have 6 or more exons per transcript, filtering out transcripts with low signal (≦6, log₂ space), and filtering in exons with multimodal distribution of expression signals. In successive filtering steps, correlations improve. In the original tri-color heatmaps, red and blue colors indicate high and low correlations, respectively. Yellow color indicates moderate correlations.

FIG. 3 illustrates hypothetical distribution of transcript expression signals per exon. Panels 3A & 3C, normal distribution. Panel 3B & 3D, bimodal distribution.

FIG. 4 is a black and white representation of a color figure which illustrates unsupervised clustering using alternative splicing index to 68 exons.

FIG. 5 illustrates correlation of alternative splicing indexes in a cohort of 68 thyroid FNA samples. Arrows indicate samples that were determined to be mixed-up: 231X & 231P; 281X & 281P; 381X & 381P.

### DETAILED DESCRIPTION OF THE INVENTION

The invention provides methods and compositions directed toward using expression information, e.g., mRNA information from a sample, or a plurality of samples, to determine an Alternative Splicing Index (ASI), which can serve as a “fingerprint” for a particular individual, for example, to determine whether one sample among several other samples comes from the same individual as the other samples. The ASI can be obtained for one gene or for a plurality of genes, to provide an Alternative Splicing Profile; such a profile can be highly individualized for a given subject. The method and compositions requires fewer samples than alternatives, such as SNP analysis, and can be used in a variety of ways. For convenience, the methods and compositions will be discussed in relation to determining whether or not there has been a sample mix-up, e.g., when expression analysis has already been performed for another purpose, e.g., for a diagnostic, prognostic, or predictive purpose, and the data gathered during that analysis may also be analyzed to determine whether or not there are any samples that have become mixed up during the sample gathering, transport, handling and/or analysis process, but it will be appreciated that the same or similar methods and compositions may be used more generally, e.g., to determine if a sample or samples in a group of samples is from the same individual.

Molecular analysis of even a single biological sample can be a multi-step process and can result in the generation of numerous sample intermediates. Sample mix-ups can occur at any step, ultimately causing analysis interpretation problems. While most laboratories implement procedures that minimize the risk of sample mix-ups, sometimes these mix-ups do occur. Disclosed herein are methods for evaluating a cohort of samples and determining whether a given sample was mixed-up with another.

In a microarray-enabled lab, sample mix-ups are generally discovered during unsupervised clustering analysis, which can be an early step in the data mining process meant to reveal the relative genetic distances between a cohort of samples. Any sample that clusters with another not belonging to the same patient, suggests that a mix-up may have occurred. However, sometimes what may appear to be a sample-mix up, can actually be an analytical artifact. In a clinical setting, it can be critical to distinguish between these two scenarios for three reasons. First, it can be imperative to return correct results to inform clinical decisions. Second, from a population study perspective, samples suspected of mix-up can be dropped from final analyses, resulting in data loss and reduced statistical power. Third, from a discovery perspective, samples that initially present as a mix-up, but have not actually been mixed-up, can be rich in information that ought to be preserved, as its value in deciphering complex biology is unknown.

Single Nucleotide Polymorphisms (SNPs) can be valuable in the development gene signatures. Formal SNP analysis can be used as an approach to rule-in or rule-out putative sample mix-ups. However, when the only data available comes from mRNA expression gene arrays, deciphering sample mix-ups can become a difficult challenge. Formal SNP analysis can be costly, time consuming, and can require multiple probes with strategically placed polymorphisms situated at the center of each probe. In addition, SNP analysis using mRNA expression data can require a large sample cohort (>200 samples) in order to have sufficient sensitivity and specificity.

As an alternative to formal SNP analysis, the methods and compositions of the invention use signal transformations of existing gene expression data to look at alternative splicing events per exon, while simultaneously minimizing the weight of gene regulation-driven expression. Multiple probesets belonging to the same exon within a given transcript can be grouped and analyzed together in order to calculate an Alternative Splicing Index (ASI). A limitation overcome by the methods disclosed herein lies in the large distribution of patterns that can be observed for any given exon from any one subject. Alternative splicing patterns can be dominated by multiple factors, including tissue specific factors, as well as disease specific variation. Similarly, alternative splicing patterns can vary in magnitude among individuals. It is contemplated that if phenotypic variation in alternative splicing pattern were determined by the presence of germline mutations (as opposed to gene regulation-driven variation), distinct ASI clusters corresponding to a particular individual's genetic make-up could be seen. Hence, to enrich the set of alternatively spliced events with those attributed to genetic/sample identity (e.g., due to inherited germline mutations that dictate alternative splicing), exons shown to deviate from unimodal ASI distributions were selected. This approach can allow the exclusion of non-informative exons thereby enriching the contribution of informative exons, specific to the sample cohort under examination.

When a range of values is indicated herein, and the range begins with a modifier such as “greater than”, “at least”, “more than”, “about”, etc., the modifier is meant to be included for every value in the range, unless where otherwise indicated. For example, “at least 1, 2, or 3” means “at least 1, at least 2, or at least 3,” as used herein. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “About” means a referenced numeric indication plus or minus 10% of that referenced numeric indication. For example, the term about 4 would include a range of 3.6 to 4.4.

Subjects

Disclosed herein are methods of “fingerprinting” a sample using expression data so that a sample from a given individual may be identified, e.g., for identifying and/or resolving sample mix-ups that can occur during collection, transport, processing, or analysis of a plurality of biological samples each obtained from a subject. The plurality of biological samples can contain two or more biological samples; for examples, about 2-1000, 2-500, 2-250, 2-100, 2-75, 2-50, 2-25, 2-10, 10-1000, 10-500, 10-250, 10-100, 10-75, 10-50, 10-25, 25-1000, 25-500, 25-250, 25-100, 25-75, 25-50, 50-1000, 50-500, 50-250, 50-100, 50-75, 60-70, 100-1000, 100-500, 100-250, 250-1000, 250-500, 500-1000, 2, 3, 4, 5, 6, 7, 8, 9, 10, 11, 12, 13, 14, 15, 16, 17, 18, 19, 20, 21, 22, 23, 24, 25, 30, 35, 40, 45, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 90, 95, 100, 110, 120, 130, 140, 150, 160, 170, 180, 190, 200, 210, 220, 230, 240, 250, 275, 300, 325, 350, 375, 400, 425, 450, 475, 500, 550, 600, 650, 700, 750, 800, 850, 900, 950, 1000, or more biological samples. The biological samples can be obtained from a plurality of subjects, giving a plurality of sets of a plurality of samples. The biological samples can be obtained from about 2 to about 1000 subjects, or more; for example, about 2-1000, 2-500, 2-250, 2-100, 2-50, 2-25, 2-20, 2-10, 10-1000, 10-500, 10-250, 10-100, 10-50, 10-25, 10-20, 15-20, 25-1000, 25-500, 25-250, 25-100, 25-50, 50-1000, 50-500, 50-250, 50-100, 100-1000, 100-500, 100-250, 250-1000, 250-500, 500-1000, or at least 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 68, 70, 75, 80, 85, 90, 95, 100, 110, 120, 130, 140, 150, 160, 170, 180, 190, 200, 210, 220, 230, 240, 250, 275, 300, 325, 350, 375, 400, 425, 450, 475, 500, 550, 600, 650, 700, 750, 800, 850, 900, 950, 1000, or more subjects.

The subjects can be any subject that produces mRNA that is subject to alternative splicing, e.g., the subject may be a eukaryotic subject, such as a plant, an animal, and in some cases a mammal, e.g., human

The biological samples can be obtained from human subjects. The biological samples can be obtained from human subjects at different ages. The human subject can be prenatal (e.g., a fetus), a child (e.g., a neonate, an infant, a toddler, a preadolescent), an adolescent, a pubescent, or an adult (e.g., an early adult, a middle aged adult, a senior citizen). The human subject can be between about 0 months and about 120 years old, or older. The human subject can be between about 0 and about 12 months old; for example, about 1, 2, 3, 4, 5, 6, 7, 8, 9, 10, 11, or 12 months old. The human subject can be between about 0 and 12 years old; for example, between about 0 and 30 days old; between about 1 month and 12 months old; between about 1 year and 3 years old; between about 4 years and 5 years old; between about 4 years and 12 years old; about 1, 2, 3, 4, 5, 6, 7, 8, 9, 10, 11, or 12 years old. The human subject can be between about 13 years and 19 years old; for example, about 13, 14, 15, 16, 17, 18, or 19 years old. The human subject can be between about 20 and about 39 year old; for example, about 20, 21, 22, 23, 24, 25, 26, 27, 28, 29, 30, 31, 32, 33, 34, 35, 36, 37, 38, or 39 years old. The human subject can be between about 40 to about 59 years old; for example, about 40, 41, 42, 43, 44, 45, 46, 47, 48, 49, 50, 51, 52, 53, 54, 55, 56, 57, 58, or 59 years old. The human subject can be greater than 59 years old; for example, about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120 years old. The human subjects can include living subjects or deceased subjects. The human subjects can include male subjects and/or female subjects.

Disclosed herein are methods of providing a fingerprint of a sample that corresponds to the individual from which the sample came using expression data from the sample, e.g., for identifying and/or resolving sample mix-ups that can occur during collection, transport, processing, or analysis of a plurality of biological samples, wherein the samples are obtained from 2 or more subjects. Biological samples can be obtained from any suitable source that allows determination of expression levels of genes, e.g., from cells, tissues, bodily fluids or secretions, or a gene expression product derived therefrom (e.g., nucleic acids, such as DNA or RNA; polypeptides, such as protein or protein fragments). The nature of the biological sample can depend upon the nature of the subject. If a biological sample is from a subject that is a unicellular organism or a multicellular organism with undifferentiated tissue, the biological sample can comprise cells, such as a sample of a cell culture, an excision of the organism, or the entire organism. If a biological sample is from a multicellular organism, the biological sample can be a tissue sample, a fluid sample, or a secretion.

The biological samples can be obtained from different tissues. The term tissue is meant to include ensembles of cells that are of a common developmental origin and have similar or identical function. The term tissue is also meant to encompass organs, which can be a functional grouping and organization of cells that can have different origins. The biological sample can be obtained from any tissue. Suitable tissues from a plant can include, but are not limited to, epidermal tissue such as the outer surface of leaves; vascular tissue such as the xylem and phloem, and ground tissue. Suitable plant tissues can also include leaves, roots, root tips, stems, flowers, seeds, cones, shoots, stobili, pollen, or a portion or combination thereof.

The biological samples can be obtained from different tissue samples from one or more humans or non-human animals. Suitable tissues can include connective tissues, muscle tissues, nervous tissues, epithelial tissues or a portion or combination thereof. Suitable tissues can also include all or a portion of a lung, a heart, a blood vessel (e.g., artery, vein, capillary), a salivary gland, a esophagus, a stomach, a liver, a gallbladder, a pancreas, a colon, a rectum, an anus, a hypothalamus, a pituitary gland, a pineal gland, a thyroid, a parathyroid, an adrenal gland, a kidney, a ureter, a bladder, a urethra, a lymph node, a tonsil, an adenoid, a thymus, a spleen, skin, muscle, a brain, a spinal cord, a nerve, an ovary, a fallopian tube, a uterus, vaginal tissue, a mammary gland, a testicle, a vas deferens, a seminal vesicle, a prostate, penile tissue, a pharynx, a larynx, a trachea, a bronchi, a diaphragm, bone marrow, a hair follicle, or a combination thereof. A biological sample from a human or non-human animal can also include a bodily fluid, secretion, or excretion; for example, a biological sample can be a sample of aqueous humour, vitreous humour, bile, blood, blood serum, breast milk, cerebrospinal fluid, endolymph, perilymph, female ejaculate, amniotic fluid, gastric juice, menses, mucus, peritoneal fluid, pleural fluid, saliva, sebum, semen, sweat, tears, vaginal secretion, vomit, urine, feces, or a combination thereof. The biological sample can be from healthy tissue, diseased tissue, tissue suspected of being diseased, or a combination thereof.

In some embodiments the biological sample is a fluid sample, for example a sample of blood, serum, sputum, urine, semen, or other biological fluid. In certain embodiments the sample is a blood sample. In some embodiments the biological sample is a tissue sample, such as a tissue sample taken to determine the presence or absence of disease in the tissue. In certain embodiments the sample is a sample of thyroid tissue.

The biological samples can be obtained from subjects in different stages of disease progression or different conditions. Different stages of disease progression or different conditions can include healthy, at the onset of primary symptom, at the onset of secondary symptom, at the onset of tertiary symptom, during the course of primary symptom, during the course of secondary symptom, during the course of tertiary symptom, at the end of the primary symptom, at the end of the secondary symptom, at the end of tertiary symptom, after the end of the primary symptom, after the end of the secondary symptom, after the end of the tertiary symptom, or a combination thereof. Different stages of disease progression can be a period of time after being diagnosed or suspected to have a disease; for example, at least about, or at least, 1, 2, 3, 4, 5, 6, 7, 8, 9, 10, 11, 12, 13, 14, 15, 16, 17, 18, 19, 20, 21, 22, 23 or 24 hours; 1, 2, 3, 4, 5, 6, 7, 8, 9, 10, 11, 12, 13, 14, 15, 16, 17, 18, 19, 20, 21, 22, 23, 24, 25, 26, 27 or 28 days; 1, 2, 3, 4, 5, 6, 7, 8, 9, 10, 11, 12, 13, 14, 15, 16, 17, 18, 19 or 20 weeks; 1, 2, 3, 4, 5, 6, 7, 8, 9, 10, 11 or 12 months; 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 years after being diagnosed or suspected to have a disease. Different stages of disease progression or different conditions can include before, during or after an action or state; for example, treatment with drugs, treatment with a surgery, treatment with a procedure, performance of a standard of care procedure, resting, sleeping, eating, fasting, walking, running, performing a cognitive task, sexual activity, thinking, jumping, urinating, relaxing, being immobilized, being emotionally traumatized, being shock, and the like.

Obtaining Biological Samples

The methods of the present disclosure provide for analysis of a biological sample from a subject or a set of subjects. The subject(s) may be, e.g., any animal (e.g., a mammal), including but not limited to humans, non-human primates, rodents, dogs, cats, pigs, fish, and the like. The present methods and compositions can apply to biological samples from humans, as described herein.

The methods of obtaining provided herein include methods of biopsy including fine needle aspiration, core needle biopsy, vacuum assisted biopsy, incisional biopsy, excisional biopsy, punch biopsy, shave biopsy or skin biopsy. In some cases, the methods and compositions provided herein are applied to data only from biological samples obtained by FNA. In some cases, the methods and compositions provided herein are applied to data only from biological samples obtained by FNA or surgical biopsy. In some cases, the methods and compositions provided herein are applied to data only from biological samples obtained by surgical biopsy

Biological samples can be obtained from any of the tissues provided herein; including, but not limited to, skin, heart, lung, kidney, breast, pancreas, liver, muscle, smooth muscle, bladder, gall bladder, colon, intestine, brain, prostate, esophagus, or thyroid. Alternatively, the sample can be obtained from any other source; including, but not limited to, blood, sweat, hair follicle, buccal tissue, tears, menses, feces, or saliva. The biological sample can be obtained by a medical professional. The medical professional can refer the subject to a testing center or laboratory for submission of the biological sample. The subject can directly provide the biological sample. In some cases, a molecular profiling business can obtain the sample. In some cases, the molecular profiling business obtains data regarding the biological sample, such as biomarker expression level data, or analysis of such data.

A biological sample can be obtained by methods known in the art such as the biopsy methods provided herein, swabbing, scraping, phlebotomy, or any other suitable method. The biological sample can be obtained, stored, or transported using components of a kit of the present disclosure. In some cases, multiple biological samples, such as multiple thyroid samples, can be obtained for analysis, characterization, or diagnosis according to the methods of the present disclosure. In some cases, multiple biological samples, such as one or more samples from one tissue type (e.g., thyroid) and one or more samples from another tissue type (e.g., buccal) can be obtained for diagnosis or characterization by the methods of the present disclosure. In some cases, multiple samples, such as one or more samples from one tissue type (e.g., thyroid) and one or more samples from another tissue (e.g., buccal) can be obtained at the same or different times. In some cases, the samples obtained at different times are stored and/or analyzed by different methods. For example, a sample can be obtained and analyzed by cytological analysis (e.g., using routine staining) In some cases, a further sample can be obtained from a subject based on the results of a cytological analysis. The diagnosis of cancer or other condition can include an examination of a subject by a physician, nurse or other medical professional. The examination can be part of a routine examination, or the examination can be due to a specific complaint including, but not limited to, one of the following: pain, illness, anticipation of illness, presence of a suspicious lump or mass, a disease, or a condition. The subject may or may not be aware of the disease or condition. The medical professional can obtain a biological sample for testing. In some cases the medical professional can refer the subject to a testing center or laboratory for submission of the biological sample.

In some cases, the subject can be referred to a specialist such as an oncologist, surgeon, or endocrinologist for further diagnosis. The specialist can likewise obtain a biological sample for testing or refer the individual to a testing center or laboratory for submission of the biological sample. In any case, the biological sample can be obtained by a physician, nurse, or other medical professional such as a medical technician, endocrinologist, cytologist, phlebotomist, radiologist, or a pulmonologist. The medical professional can indicate the appropriate test or assay to perform on the sample, or the molecular profiling business of the present disclosure can consult on which assays or tests are most appropriately indicated. The molecular profiling business can bill the individual or medical or insurance provider thereof for consulting work, for sample acquisition and or storage, for materials, or for all products and services rendered.

A medical professional need not be involved in the initial diagnosis or sample acquisition. An individual can alternatively obtain a sample through the use of an over the counter kit. The kit can contain a means for obtaining said sample as described herein, a means for storing the sample for inspection, and instructions for proper use of the kit. In some cases, molecular profiling services are included in the price for purchase of the kit. In other cases, the molecular profiling services are billed separately.

A biological sample suitable for use by the molecular profiling business can be any material containing tissues, cells, nucleic acids, genes, gene fragments, expression products, gene expression products, and/or gene expression product fragments of an individual to be tested. Methods for determining sample suitability and/or adequacy are provided. The biological sample can include, but is not limited to, tissue, cells, and/or biological material from cells or derived from cells of an individual. The sample can be a heterogeneous or homogeneous population of cells or tissues. The biological sample can be obtained using any method known to the art that can provide a sample suitable for the analytical methods described herein.

A biological sample can be obtained by non-invasive methods, such methods including, but not limited to: scraping of the skin or cervix, swabbing of the cheek, saliva collection, urine collection, feces collection, collection of menses, tears, or semen. The biological sample can be obtained by an invasive procedure, such procedures including, but not limited to: biopsy, alveolar or pulmonary lavage, needle aspiration, or phlebotomy. The method of biopsy can further include incisional biopsy, excisional biopsy, punch biopsy, shave biopsy, or skin biopsy. The method of needle aspiration can further include fine needle aspiration, core needle biopsy, vacuum assisted biopsy, or large core biopsy. Multiple biological samples can be obtained by the methods herein to ensure a sufficient amount of biological material. Methods of obtaining suitable samples of thyroid are known in the art and are further described in the ATA Guidelines for thyroid nodule management (Cooper et al. Thyroid Vol. 16 No. 2 2006), herein incorporated by reference in its entirety. Generic methods for obtaining biological samples are also known in the art and further described in for example Ramzy, Ibrahim Clinical Cytopathology and Aspiration Biopsy 2001 which is herein incorporated by reference in its entirety. The biological sample can be a fine needle aspirate of a thyroid nodule or a suspected thyroid tumor. The fine needle aspirate sampling procedure can be guided by the use of an ultrasound, X-ray, or other imaging device.

A molecular profiling business can obtain a biological sample from a subject directly, from a medical professional, from a third party, and/or from a kit provided by the molecular profiling business or a third party. The biological sample can be obtained by the molecular profiling business after the subject, the medical professional, or the third party acquires and sends the biological sample to the molecular profiling business. The molecular profiling business can provide suitable containers and/or excipients for storage and transport of the biological sample to the molecular profiling business.

Obtaining a biological sample can be aided by the use of a kit.

A kit can be provided containing materials for obtaining, storing, and/or shipping biological samples. The kit can contain, for example, materials and/or instruments for the collection of the biological sample (e.g., sterile swabs, sterile cotton, disinfectant, needles, syringes, scalpels, anesthetic swabs, knives, curette blade, liquid nitrogen, etc.). The kit can contain, for example, materials and/or instruments for the storage and/or preservation of biological samples (e.g., containers; materials for temperature control such as ice, ice packs, cold packs, dry ice, liquid nitrogen; chemical preservatives or buffers such as formaldehyde, formalin, paraformaldehyde, glutaraldehyde, alcohols such as ethanol or methanol, acetone, acetic acid, HOPE fixative (Hepes-glutamic acid buffer-mediated organic solvent protection effect), heparin, saline, phosphate buffered saline, TAPS, bicine, Tris, tricine, TAPSO, HEPES, TES, MOPS, PIPES, cadodylate, SSC, MES, phosphate buffer; protease inhibitors such as aprotinin, bestatin, calpain inhibitor I and II, chymostatin, E-64, leupeptin, alpha-2-macroglobulin, pefabloc SC, pepstatin, phenylmethanesufonyl fluoride, trypsin inhibitors; DNAse inhibitors such as 2-mercaptoethanol, 2-nitro-5-thicyanobenzoic acid, calcium, EGTA, EDTA, sodium dodecyl sulfate, iodoacetate, etc.; RNAse inhibitors such as ribonuclease inhibitor protein; double-distilled water; DEPC (diethyprocarbonate) treated water, etc.). The kit can contain instructions for use. The kit can be provided as, or contain, a suitable container for shipping. The shipping container can be an insulated container. The shipping container can be self addressed to a collection agent (e.g., laboratory, medical center, genetic testing company, etc.). The kit can be provided to a subject for home use or use by a medical professional. Alternatively, the kit can be provided directly to a medical professional.

One or more biological samples can be obtained from a given subject. In some cases, between about 1 and about 50 biological samples are obtained from the given subject; for example, about 1-50, 1-40, 1-30, 1-25, 1-20, 1-15, 1-10, 1-7, 1-5, 5-50, 5-40, 5-30, 5-25, 5-15, 5-10, 10-50, 10-40, 10-25, 10-20, 25-50, 25-40, or at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 biological samples can be obtained from the given subject. Multiple biological samples from the given subject can be obtained from the same source (e.g., the same tissue), e.g., multiple blood samples, or multiple tissue samples, or from multiple sources (e.g., multiple tissues). Multiple biological samples from the given subject can be obtained at the same time or at different times. Multiple biological samples from the given subject can be obtained at the same condition or different condition. Multiple biological samples from the given subject can be obtained at the same disease progression or different disease progression of the subject. If multiple biological samples are collected from the same source (e.g., the same tissue) from the particular subject, the samples can be combined into a single sample. Combining samples in this way can ensure that enough material is obtained for testing and/or analysis.

Transport of Biological Samples

In some cases, he methods of the present disclosure provide for transport of a biological sample. In some cases, the biological sample is transported from a clinic, hospital, doctor's office, or other location to a second location whereupon the sample can be stored and/or analyzed by, for example, cytological analysis or molecular profiling. The biological samples can be transported to a molecular profiling company in order to perform the analyses described herein. In other cases, the biological sample can be transported to a laboratory, such as a laboratory authorized or otherwise capable of performing the methods of the present disclosure, such as a Clinical Laboratory Improvement Amendments (CLIA) laboratory. The biological sample can be transported by the subject from whom the biological sample derives. The transportation by the subject can include the subject appearing at a molecular profiling business or a designated sample receiving point and providing the biological sample. The providing of the biological sample can involve any of the techniques of sample acquisition described herein, or the biological sample can have already have been acquired and stored in a suitable container as described herein. The biological sample can be transported to a molecular profiling business using a courier service, the postal service, a shipping service, or any method capable of transporting the biological sample in a suitable manner. The biological sample can be provided to the molecular profiling business by a third party testing laboratory (e.g., a cytology lab). In other cases, the biological sample can be provided to the molecular profiling business by the subject's primary care physician, endocrinologist or other medical professional. The cost of transport can be billed to the subject, medical provider, or insurance provider. The molecular profiling business can begin analysis of the sample immediately upon receipt, or can store the sample in any manner described herein. The method of storage can optionally be the same as chosen prior to receipt of the sample by the molecular profiling business.

A biological sample can be transported in any medium or excipient, including any medium or excipient provided herein suitable for storing the biological sample such as a cryopreservation medium or a liquid based cytology preparation. The biological sample can be transported frozen or refrigerated, such as at any of the suitable sample storage temperatures provided herein.

Upon receipt of a biological sample by a molecular profiling business, a representative or licensee thereof, a medical professional, researcher, or a third party laboratory or testing center (e.g., a cytology laboratory), the biological sample can be assayed using a variety of analyses, such as cytological assays and genomic analysis. Such assays or tests can be indicative of cancer, a type of cancer, any other disease or condition, the presence of disease markers, the presence of genetic mutations, or the absence of cancer, diseases, conditions, or disease markers. The tests can take the form of cytological examination including microscopic examination. The tests can involve the use of one or more cytological stains. The biological sample can be manipulated or prepared for the test prior to administration of the test by any suitable method known to the art for biological sample preparation. The specific assay performed can be determined by the molecular profiling business, the physician who ordered the test, or a third party such as a consulting medical professional, cytology laboratory, the subject from whom the sample derives, and/or an insurance provider. The specific assay can be chosen based on the likelihood of obtaining a definite diagnosis, the cost of the assay, the speed of the assay, or the suitability of the assay to the type of material provided.

Storage of Biological Samples

Biological samples can be stored for a period of time prior to processing or analysis of the biological samples. The period of time biological samples can be stored can be measured in seconds, minutes, hours, days, weeks, months, years or longer. The biological samples can be subdivided. Subdivided biological samples can be stored, processed, or a combination thereof. Subdivided biological samples can be subject to different downstream processes (e.g., storage, cytological analysis, adequacy tests, nucleic acid extraction, molecular profiling and/or a combination thereof).

A portion of a biological sample can be stored while another portion of the biological sample is further manipulated. Such manipulations can include, but are not limited to, molecular profiling; cytological staining; nucleic acid (RNA or DNA) extraction, detection, or quantification; gene expression product (e.g., RNA or protein) extraction, detection, or quantification; fixation (e.g., formalin fixed paraffin embedded samples); and/or examination. The biological sample can be fixed prior to or during storage by any method known to the art, such methods including, but not limited to, the use of glutaraldehyde, formaldehyde, and/or methanol. In other cases, the sample is obtained and stored and subdivided after the step of storage for further analysis such that different portions of the sample are subject to different downstream methods or processes including but not limited to storage, cytological analysis, adequacy tests, nucleic acid extraction, molecular profiling or a combination thereof. In some cases, one or more biological samples are obtained and analyzed by cytological analysis, and the resulting sample material is further analyzed by one or more molecular profiling methods of the present disclosure. In such cases, the biological samples can be stored between the steps of cytological analysis and the steps of molecular profiling. The biological samples can be stored upon acquisition; for example, to facilitate transport or to wait for the results of other analyses. Biological samples can be stored while awaiting instructions from a physician or other medical professional.

A biological sample can be placed in a suitable medium, excipient, solution, and/or container for short term or long term storage. The storage can involve keeping the biological sample in a refrigerated or frozen environment. The biological sample can be quickly frozen prior to storage in a frozen environment. The biological sample can be contacted with a suitable cryopreservation medium or compound prior to, during, and/or after cooling or freezing the biological sample. The cryopreservation medium or compound can include, but is not limited to: glycerol, ethylene glycol, sucrose, and/or glucose. The suitable medium, excipient, or solution can include, but is not limited to: hanks salt solution; saline; cellular growth medium; an ammonium salt solution, such as ammonium sulphate or ammonium phosphate; and/or water. Suitable concentrations of ammonium salts can include solutions of between about 0.1 g/mL to 2.5 g/L, or higher; for example, about 0.1 g/ml, 0.2 g/ml, 0.3 g/ml, 0.4 g/ml, 0.5 g/ml, 0.6 g/ml, 0.7 g/ml, 0.8 g/ml, 0.9 g/ml, 1.0 g/ml, 1.1 g/ml, 1.2 g/ml, 1.3 g/ml, 1.4 g/ml, 1.5 g/ml, 1.6 g/ml, 1.7 g/ml, 1.8 g/ml, 1.9 g/ml, 2.0 g/ml, 2.2 g/ml, 2.3 g/ml, 2.5 g/ml or higher. The medium, excipient, or solution can optionally be sterile.

A biological sample can be stored at room temperature; at reduced temperatures, such as cold temperatures (e.g., between about 20° C. and about 0° C.); and/or freezing temperatures, including for example about 0° C., −1° C., −2° C., −3° C., −4° C., −5° C., −6° C., −7° C., −8° C., −9° C., −10° C., −12° C., −14° C., −15° C., −16° C., −20° C., −22° C., −25° C., −28° C., −30° C., −35° C., −40° C., −45° C., −50° C., −60° C., −70° C., −80° C., −100° C., −120° C., −140° C., −180° C., −190° C., or −200° C. The biological samples can be stored in a refrigerator, on ice or a frozen gel pack, in a freezer, in a cryogenic freezer, on dry ice, in liquid nitrogen, and/or in a vapor phase equilibrated with liquid nitrogen.

A medium, excipient, or solution for storing a biological sample can contain preservative agents to maintain the sample in an adequate state for subsequent diagnostics or manipulation, or to prevent coagulation. Said preservatives can include, but are not limited to, citrate, ethylene diamine tetraacetic acid, sodium azide, and/or thimersol. The medium, excipient or solution can contain suitable buffers or salts such as Tris buffers, phosphate buffers, sodium salts (e.g., NaCl), calcium salts, magnesium salts, and the like. In some cases, the sample can be stored in a commercial preparation suitable for storage of cells for subsequent cytological analysis, such preparations including, but not limited to Cytyc ThinPrep, SurePath, and/or Monoprep.

A sample container can be any container suitable for storage and or transport of a biological sample; such containers including, but not limited to: a cup, a cup with a lid, a tube, a sterile tube, a vacuum tube, a syringe, a bottle, a microscope slide, or any other suitable container. The container can optionally be sterile.

Test for Adequacy of Biological Samples

Subsequent to or during biological sample acquisition, including before or after a step of storing the sample, the biological material can be assessed for adequacy, for example, to assess the suitability of the sample for use in the methods and compositions of the present disclosure. The assessment can be performed by an individual who obtains the sample; a molecular profiling business; an individual using a kit; or a third party, such as a cytological lab, pathologist, endocrinologist, or a researcher. The sample can be determined to be adequate or inadequate for further analysis due to many factors, such factors including, but not limited to: insufficient cells; insufficient genetic material; insufficient protein, DNA, or RNA; inappropriate cells for the indicated test; inappropriate material for the indicated test; age of the sample; manner in which the sample was obtained; and/or manner in which the sample was stored or transported. Adequacy can be determined using a variety of methods known in the art such as a cell staining procedure, measurement of the number of cells or amount of tissue, measurement of total protein, measurement of nucleic acid levels, visual examination, microscopic examination, or temperature or pH determination. Sample adequacy can be determined from a result of performing a gene expression product level analysis experiment. Sample adequacy can be determined by measuring the content of a marker of sample adequacy. Such markers can include elements such as iodine, calcium, magnesium, phosphorous, carbon, nitrogen, sulfur, iron etc.; proteins such as, but not limited to, thyroglobulin; cellular mass; and cellular components such as protein, nucleic acid, lipid, or carbohydrate.

Cell and/or Tissue Content Adequacy Test

Methods for determining the amount of a tissue in a biological sample can include, but are not limited to, weighing the sample or measuring the volume of sample. Methods for determining the amount of cells in the biological sample can include, but are not limited to, counting cells, which can in some cases be performed after dis-aggregation of the biological sample (e.g., with an enzyme such as trypsin or collagenase or by physical means such as using a tissue homogenizer). Alternative methods for determining the amount of cells in the biological sample can include, but are not limited to, quantification of dyes that bind to cellular material or measurement of the volume of cell pellet obtained following centrifugation. Methods for determining that an adequate number of a specific type of cell is present in the biological sample can also include PCR, Q-PCR, RT-PCR, immuno-histochemical analysis, cytological analysis, microscopic, and or visual analysis.

Nucleic Acid Content Adequacy Test

Biological samples can be tested for adequacy; for example, by analysis of nucleic acid content after extraction from the biological sample using a variety of methods known to the art. Nucleic acids, such as RNA or mRNA, can be extracted from other nucleic acids prior to nucleic acid content analysis. Nucleic acid content can be extracted, purified, and measured by ultraviolet absorbance, including but not limited to absorbance at 260 nanometers using a spectrophotometer. Nucleic acid content or adequacy can be measured by fluorometer after contacting the sample with a stain. Nucleic acid content or adequacy can be measured after electrophoresis, or using an instrument such as an Agilent bioanalyzer.

It can be useful to measure the quantity or yield of nucleic acids (e.g., DNA, RNA, etc.). The yield of nucleic acids can be measured immediately after extracting the nucleic acids from the biological sample. The yield of nucleic acids can also be measured after storing the extracted nucleic acids for a period of time. The yield of nucleic acids can be measured following an experimental manipulation or transformation of the extracted nucleic acids. For example, RNA can be extracted and/or purified from a biological sample and subjected to reverse transcriptase PCR after which the cDNA levels can be measured to determine adequacy. If a specific type of nucleic acid is desired (e.g., DNA, RNA, mRNA, etc.), the quantity of yield of the specific type of nucleic acid can be measured after purification. The quantity or yield of nucleic acids can be measured using spectrophotometry. The quantity or yield of nucleic acids (e.g., DNA and/or RNA) from a biological sample can be measured shortly after purification, for example, using a NanoDrop spectrophotometer in a range of nano- to micrograms. The NanoDrop is a cuvette-free spectrophotometer. It can use 1 μL to measure from about 5 ng/μL to about 3,000 ng/μL of sample. Features of the NanoDrop include low volume of sample and no cuvette; large dynamic range 5 ng/μL to 3,000 ng/μL; and it allows quantitation of DNA, RNA and proteins. NanoDrop™ 2000c allows for the analysis of 0.5 μL-2.0 μL, samples, without the need for cuvettes or capillaries. The NanoDrop is presented as an exemplary instrument to measure nucleic acid quantities or yields; however, any instrument or method known in the art can be used in the methods disclosed herein.

A threshold yield of nucleic acids can be required during adequacy testing of biological samples. The threshold yield of nucleic acids can be between about 1 ng to about 100 μg or more; for example, the threshold yield can be about 1 ng-100 μg, 1 ng-10 μg, 1 ng-5 μg, 1 ng-1 μg, 1 ng-500 ng, 1 ng-250 ng, 1 ng-50 ng, 1 ng-10 ng, 10 ng-100 μg, 10 ng-10 μg, 10 ng-5 μg, 10 ng-1 μg, 10 ng-500 ng, 10 ng-250 ng, 10 ng-50 ng, 50 ng-100 μg, 50 ng-10 μg, 50 ng-5 μg, 50 ng-1 μg, 50 ng-500 ng, 50 ng-250 ng, 250 ng-100 μg, 250 ng-10 μg, 250 ng-5 μg, 250 ng-1 μg, 250 ng-500 ng, 500 ng-100 μg, 500 ng-10 μg, 500 ng-5 μg, 500 ng-1 μg, 1 μg-100 μg, 1 μg-10 μg, 1 μg-5 μg, 5 μg-100 μg, 5 μg-10 μg, 10 μg-100 μg, or any intervening range. The threshold yield of a nucleic acid (e.g., DNA and/or RNA) for an adequate biological can be about 1 ng, 2 ng, 3 ng, 4 ng, 5 ng, 6 ng, 7 ng, 8 ng, 9 ng, 10 ng, 15 ng, 20 ng, 25 ng, 30 ng, 35 ng, 40 ng, 45 ng, 50 ng, 60 ng, 70 ng, 80 ng, 90 ng, 100 ng, 125 ng, 150 ng, 175 ng, 200 ng, 225 ng, 250 ng, 300 ng, 350 ng, 400 ng, 450 ng, 500 ng, 600 ng, 700 ng, 800 ng, 900 ng, 1 μg, 1.5 μg, 2 μg, 2.5 μg, 3 μg, 3.5 μg, 4 μg, 4.5 μg, 5 μg, 6 μg, 7 μg, 8 μg, 9 μg, 10 μg, 15 μg, 20 μg, 25 μg, 30 μg, 35 μg, 40 μg, 45 μg, 50 μg, 60 μg, 70 μg, 80 μg, 90 μg, 100 μg, or any intervening amount, or more. The threshold yield of nucleic acids for adequacy testing of biological samples can vary depending upon the intended method of analysis (e.g., microarray, southern blot, northern blot, sequencing, RT-PCR, serial analysis of gene expression (SAGE), etc.).

It can be useful to measure RNA quality when testing a biological sample for adequacy. RNA quality in a biological sample can be measured by a calculated RNA Integrity Number (RIN). RNA quality can be measured using an Agilent 2100 Bioanalyzer instrument, wherein quality is characterized by a calculated RNA Integrity Number (RIN, 1-10). The RNA integrity number (RIN) is an algorithm for assigning integrity values to RNA measurements. The integrity of RNA can be a major concern for gene expression studies and traditionally has been evaluated using the 28S to 18S rRNA ratio, a method that can be inconsistent. The RIN algorithm is applied to electrophoretic RNA measurements and based on a combination of different features that contribute information about the RNA integrity to provide a more robust universal measure. RNA quality can be measured using an Agilent 2100 Bioanalyzer instrument. Protocols for measuring RNA quality are known and available commercially, for example, at Agilent website. Briefly, in the first step, researchers deposit total RNA sample into an RNA Nano LabChip. In the second step, the LabChip is inserted into the Agilent bioanalyzer and the analysis is run, generating a digital electropherogram. In the third step, the RIN algorithm then analyzes the entire electrophoretic trace of the RNA sample, including the presence or absence of degradation products, to determine sample integrity. Then, the algorithm assigns a 1 to 10 RIN score, where level 10 RNA is completely intact. Because interpretation of the electropherogram is automatic and not subject to individual interpretation, universal and unbiased comparison of samples can be enabled and repeatability of experiments can be improved. The RIN algorithm was developed using neural networks and adaptive learning in conjunction with a large database of eukaryote total RNA samples, which were obtained mainly from human, rat, and mouse tissues. Advantages of RIN can include obtaining a numerical assessment of the integrity of RNA; directly comparing RNA samples (e.g., before and after archival, between different labs); and ensuring repeatability of experiments [e.g., if RIN shows a given value and is suitable for microarray experiments, then the RIN of the same value can always be used for similar experiments given that the same organism/tissue/extraction method is used (Schroeder A, et al. BMC Molecular Biology 2006, 7:3 (2006)), which is hereby incorporated by reference in its entirety].

The quality of RNA derived, purified, or extracted from a biological sample can be measured on a scale of RIN 1 to 10, with 10 being the highest quality. The biological sample can be determined to be inadequate if the RNA quality is measured to be below a threshold value; for example, the threshold value can be an RIN of about 1, 2, 3, 4, 5, 6, 7, 8, 9, or 10. In some cases, a threshold level of RNA quality is not used in determining the adequacy of a biological sample.

Assaying gene expression in a biological sample can be a complex, dynamic, and expensive process. RNA samples with RIN≦5.0 are typically not used for multi-gene microarray analysis, and can be limited to single-gene RT-PCR and/or TaqMan assays. This dichotomy in the usefulness of RNA according to quality can limit the usefulness of samples and hamper research and/or diagnostic efforts. The present disclosure provides methods via which low quality RNA can be used to obtain meaningful multi-gene expression results from samples containing low concentrations of RNA.

In addition, samples having a low and/or un-measurable RNA concentration by NanoDrop normally deemed inadequate for multi-gene expression analysis, can be measured and analyzed using the subject methods and algorithms of the present disclosure. A sensitive apparatus that can be used to measure nucleic acid yield is the NanoDrop spectrophotometer. Like many quantitative instruments of its kind, the accuracy of a NanoDrop measurement can decrease significantly with very low RNA concentration. The minimum amount of RNA necessary for input into a microarray experiment also limits the usefulness of a given sample. In the present disclosure, a sample containing a very low amount of nucleic acid can be estimated using a combination of the measurements from both the NanoDrop and the Bioanalyzer instruments, thereby optimizing the sample for multi-gene expression assays and analysis.

Protein Content Adequacy Test

Protein content in a biological sample can be measured using a variety of methods, including, but not limited to: ultraviolet absorbance at 280 nanometers, cell staining, or protein staining (e.g., with Coomassie blue or bichichonic acid). Protein can be extracted from the biological sample prior to measurement of the sample. Multiple tests for adequacy of the sample can be performed in parallel, or one at a time. The biological sample can be divided into aliquots for the purpose of performing multiple diagnostic tests prior to, during, or after assessing adequacy. Any adequacy test can be performed on a portion or aliquot of the biological sample (or materials derived therefrom). The portion or aliquot of the biological sample (or materials derived therefrom) used for an adequacy test may or may not be suitable for further diagnostic testing. The entire sample can be assessed for adequacy. In any case, the test for adequacy can be billed to the subject, medical provider, insurance provider, or government entity.

A biological sample can be tested for adequacy soon or immediately after collection. In some cases, when the sample adequacy test does not indicate a sufficient amount sample or sample of sufficient quality, additional samples can be taken.

Test for Iodine Levels

Iodine can be measured by a chemical method such as described in U.S. Pat. No. 3,645,691 which is incorporated herein by reference in its entirety or other chemical methods known in the art for measuring iodine content. Chemical methods for iodine measurement include but are not limited to methods based on the Sandell and Kolthoff reaction. Said reaction proceeds according to the following equation:

2Ce⁴⁺+As³+→2Ce³⁺+As⁵+I.

Iodine can have a catalytic effect upon the course of the reaction, e.g., the more iodine present in the preparation to be analyzed, the more rapidly the reaction proceeds. The speed of reaction is proportional to the iodine concentration. In some cases, this analytical method can carried out in the following manner: A predetermined amount of a solution of arsenous oxide As₂O₃ in concentrated sulfuric or nitric acid is added to the biological sample and the temperature of the mixture is adjusted to reaction temperature, i.e., usually to a temperature between 20° C. and 60° C. A predetermined amount of a cerium (IV) sulfate solution in sulfuric or nitric acid is added thereto. Thereupon, the mixture is allowed to react at the predetermined temperature for a definite period of time. Said reaction time is selected in accordance with the order of magnitude of the amount of iodine to be determined and with the respective selected reaction temperature. The reaction time is usually between about 1 minute and about 40 minutes. Thereafter, the content of the test solution of cerium (IV) ions is determined photometrically. The lower the photometrically determined cerium (IV) ion concentration is, the higher is the speed of reaction and, consequently, the amount of catalytic agent, i.e., of iodine. In this manner the iodine of the sample can directly and quantitatively be determined.

Iodine content of a sample of thyroid tissue can also be measured by detecting a specific isotope of iodine such as for example ¹²³I, ¹²⁴I, ¹²⁵I, and ¹³¹I. In still other cases, the marker can be another radioisotope such as an isotope of carbon, nitrogen, sulfur, oxygen, iron, phosphorous, or hydrogen. The radioisotope in some instances can be administered prior to sample collection. Methods of radioisotope administration suitable for adequacy testing are well known in the art and include injection into a vein or artery, or by ingestion. A suitable period of time between administration of the isotope and acquisition of thyroid nodule sample so as to effect absorption of a portion of the isotope into the thyroid tissue can include any period of time between about a minute and a few days or about one week including about 1 minute, 2 minutes, 5 minutes, 10 minutes, 15 minutes, ½ an hour, an hour, 8 hours, 12 hours, 24 hours, 48 hours, 72 hours, or about one, one and a half, or two weeks, and can readily be determined by one skilled in the art. Alternatively, samples can be measured for natural levels of isotopes such as radioisotopes of iodine, calcium, magnesium, carbon, nitrogen, sulfur, oxygen, iron, phosphorous, or hydrogen.

Gene Expression Products

Gene expression experiments often involve measuring the relative amount of gene expression products, such as mRNA, expressed in two or more experimental conditions. This is because altered levels of a specific sequence of a gene expression product can suggest a changed need for the protein coded for by the gene expression product, perhaps indicating a homeostatic response or a pathological condition.

In some embodiments, the method involves measuring, assaying or obtaining the expression levels of one or more genes. In some cases, the method provides a number, or a range of numbers, of genes that the expression levels of the genes can be used to diagnose, characterize or categorize a biological sample. The number of genes used can be between about 1 and about 500; for example about 1-500, 1-400, 1-300, 1-200, 1-100, 1-50, 1-25, 1-10, 10-500, 10-400, 10-300, 10-200, 10-100, 10-50, 10-25, 25-500, 25-400, 25-300, 25-200, 25-100, 25-50, 50-500, 50-400, 50-300, 50-200, 50-100, 100-500, 100-400, 100-300, 100-200, 200-500, 200-400, 200-300, 300-500, 300-400, 400-500, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, or any included range or integer. For example, at least about 1, 2, 3, 4, 5, 6, 7, 8, 9, 10, 15, 20, 25, 30, 33, 35, 38, 40, 43, 45, 48, 50, 53, 58, 63, 65, 68, 100, 120, 140, 142, 145, 147, 150, 152, 157, 160, 162, 167, 175, 180, 185, 190, 195, 200, 300, 400, 500 or more total genes can be used. The number of genes used can be less than or equal to about 1, 2, 3, 4, 5, 6, 7, 8, 9, 10, 15, 20, 25, 30, 33, 35, 38, 40, 43, 45, 48, 50, 53, 58, 63, 65, 68, 100, 120, 140, 142, 145, 147, 150, 152, 157, 160, 162, 167, 175, 180, 185, 190, 195, 200, 300, 400, 500, or more.

In some embodiments, the gene expression data corresponds to data of an expression level of one or more biomarkers that are related to a disease or condition. In some embodiments, the disease or condition is cancer; for example, thyroid cancer. Thyroid cancer includes any type of thyroid cancer, including but not limited to, any malignancy of the thyroid gland, e.g., papillary thyroid cancer, follicular thyroid cancer, medullary thyroid cancer and/or anaplastic thyroid cancer. In some cases, the disease or condition is one or more of the following types of thyroid cancer: papillary thyroid carcinoma (PTC), follicular variant of papillary thyroid carcinoma (FVPTC), follicular carcinoma (FC), Hurthle cell carcinoma (HC) or medullary thyroid carcinoma (MTC). In some embodiments, the gene expression data corresponds to data of an expression level of one or more biomarkers that are related to one or more types of cancer; for example, adrenal cortical cancer, anal cancer, aplastic anemia, bile duct cancer, bladder cancer, bone cancer, bone metastasis, central nervous system (CNS) cancers, peripheral nervous system (PNS) cancers, breast cancer, Castleman's disease, cervical cancer, childhood Non-Hodgkin's lymphoma, lymphoma, colon and rectum cancer, endometrial cancer, esophagus cancer, Ewing's family of tumors (e.g. Ewing's sarcoma), eye cancer, gallbladder cancer, gastrointestinal carcinoid tumors, gastrointestinal stromal tumors, gestational trophoblastic disease, hairy cell leukemia, Hodgkin's disease, Kaposi's sarcoma, kidney cancer, laryngeal and hypopharyngeal cancer, acute lymphocytic leukemia, acute myeloid leukemia, children's leukemia, chronic lymphocytic leukemia, chronic myeloid leukemia, liver cancer, lung cancer, lung carcinoid tumors, Non-Hodgkin's lymphoma, male breast cancer, malignant mesothelioma, multiple myeloma, myelodysplastic syndrome, myeloproliferative disorders, nasal cavity and paranasal cancer, nasopharyngeal cancer, neuroblastoma, oral cavity and oropharyngeal cancer, osteosarcoma, ovarian cancer, pancreatic cancer, penile cancer, pituitary tumor, prostate cancer, retinoblastoma, rhabdomyosarcoma, salivary gland cancer, sarcoma (adult soft tissue cancer), melanoma skin cancer, non-melanoma skin cancer, stomach cancer, testicular cancer, thymus cancer, uterine cancer (e.g. uterine sarcoma), vaginal cancer, vulvar cancer, and Waldenstrom's macroglobulinemia.

Measuring Expression Levels of Gene Expression Products

In one such embodiment, the relative gene expression, as compared to normal cells and/or tissues of the same organ, is determined by measuring the relative rates of transcription of RNA, such as by production of corresponding cDNAs and then analyzing the resulting DNA using probes developed from the gene sequences as corresponding to a genetic marker. Thus, the levels of cDNA produced by use of reverse transcriptase with the full RNA complement of a cell suspected of being cancerous produces a corresponding amount of cDNA that can then be amplified using polymerase chain reaction, or some other means, such as linear amplification, isothermal amplification, NASB, or rolling circle amplification, to determine the relative levels of resulting cDNA and, thereby, the relative levels of gene expression. The general methods for determining gene expression product levels are known to the art and may include but are not limited to one or more of the following: additional cytological assays, assays for specific proteins or enzyme activities, assays for specific expression products including protein or RNA or specific RNA splice variants, in situ hybridization, whole or partial genome expression analysis, microarray hybridization assays, SAGE, enzyme linked immuno-absorbance assays, mass-spectrometry, immuno-histochemistry, blotting, microarray, RT-PCR, quantitative PCR, sequencing, RNA sequencing, DNA sequencing (e.g., sequencing of cDNA obtained from RNA); Next-Gen sequencing, nanopore sequencing, pyrosequencing, or Nanostring sequencing. Gene expression product levels may be normalized to an internal standard such as total mRNA or the expression level of a particular gene including but not limited to glyceraldehyde 3 phosphate dehydrogenase, or tublin.

Gene expression data generally comprises the measurement of the activity (or the expression) of a plurality of genes, to create a picture of cellular function. Gene expression data can be used, for example, to distinguish between cells that are actively dividing, or to show how the cells react to a particular treatment. Microarray technology can be used to measure the relative activity of previously identified target genes and other expressed sequences. Sequence based techniques, like serial analysis of gene expression (SAGE, SuperSAGE) are also used for assaying, measuring or obtaining gene expression data. SuperSAGE is especially accurate and can measure any active gene, not just a predefined set. In an RNA, mRNA or gene expression profiling microarray, the expression levels of thousands of genes can be simultaneously monitored to study the effects of certain treatments, diseases, and developmental stages on gene expression.

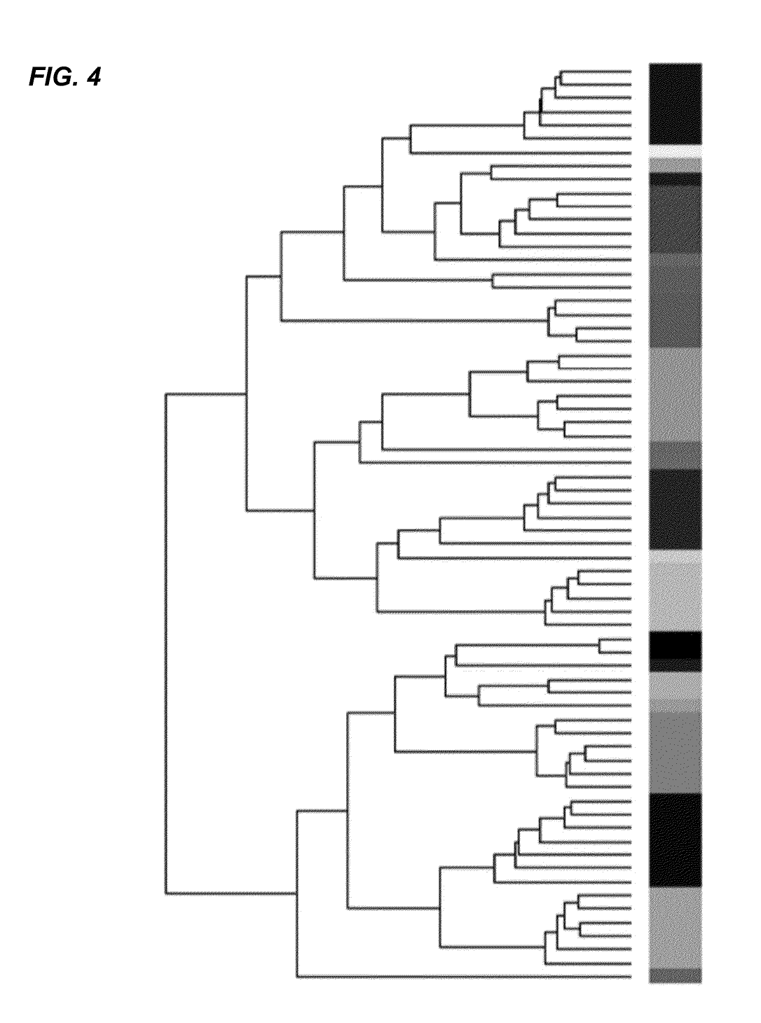

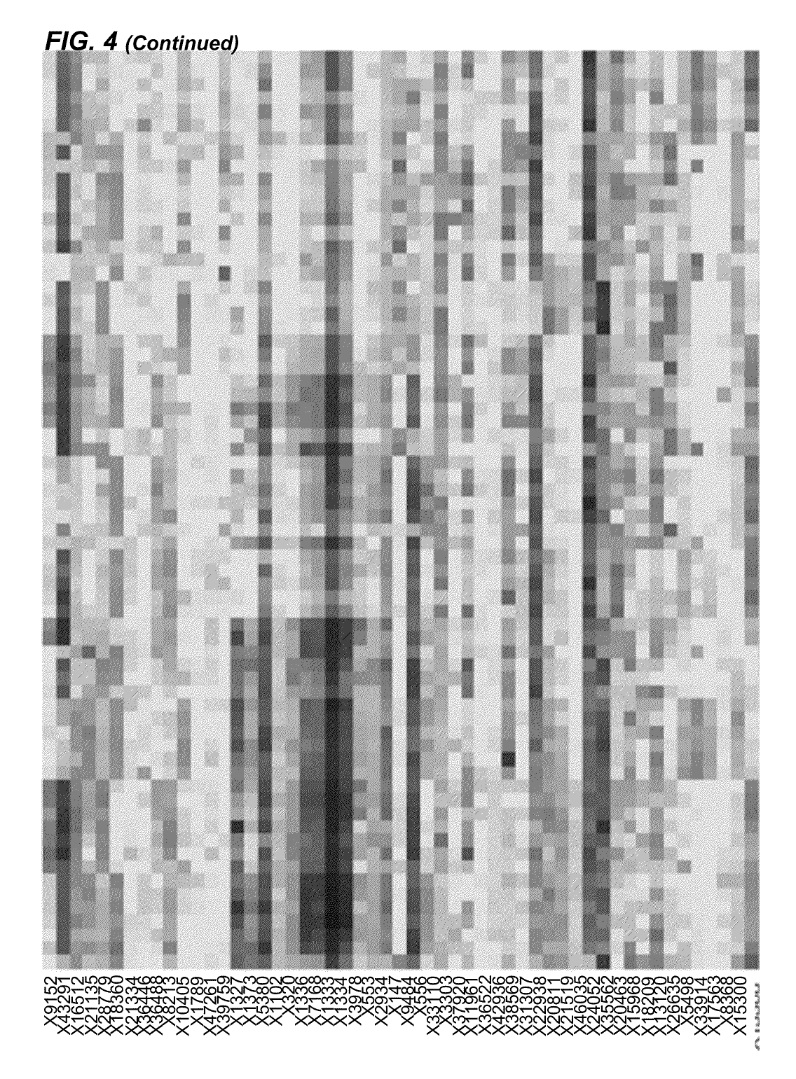

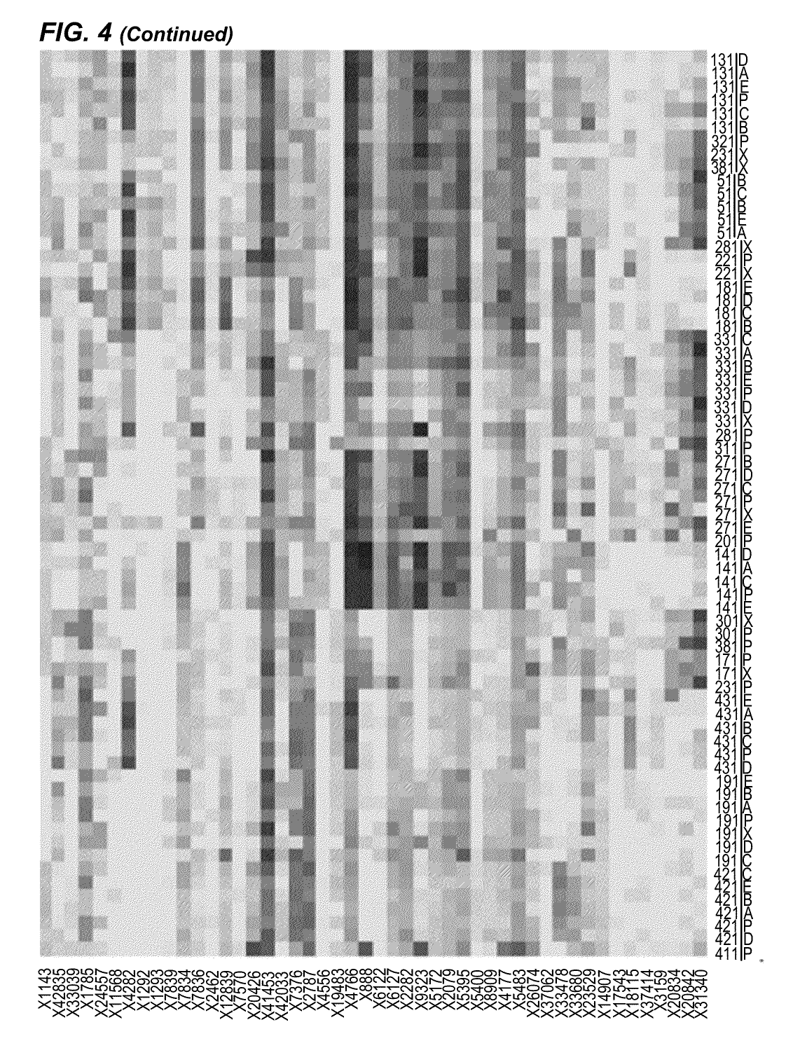

In accordance with the foregoing, the expression level of a gene, genes, markers, gene expression products, mRNA, miRNAs, or a combination thereof as disclosed herein may be determined using northern blotting and employing the sequences as identified herein to develop probes for this purpose. Such probes may be composed of DNA or RNA or synthetic nucleotides or a combination of these and may advantageously be comprised of a contiguous stretch of nucleotide residues matching, or complementary to, a sequence corresponding to a genetic marker identified in FIG. 4. Such probes will most usefully comprise a contiguous stretch of at least 15-200 residues or more including 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 80, 85, 90, 95, 100, 110, 120, 130, 140, 150, 160, 175, or 200 nucleotides or more. Thus, where a single probe binds multiple times to the transcriptome of experimental cells, whereas binding of the same probe to a similar amount of transcriptome derived from the genome of control cells of the same organ or tissue results in observably more or less binding, this is indicative of differential expression of a gene, multiple genes, markers, or miRNAs comprising, or corresponding to, the sequences corresponding to a genetic marker from which the probe sequence was derived.

In some embodiments of the present invention, gene expression may be determined by microarray analysis using, for example, Affymetrix arrays, cDNA microarrays, oligonucleotide microarrays, spotted microarrays, or other microarray products from Biorad, Agilent, or Eppendorf. Microarrays provide particular advantages because they may contain a large number of genes or alternative splice variants that may be assayed in a single experiment. In some cases, the microarray device may contain the entire human genome or transcriptome or a substantial fraction thereof allowing a comprehensive evaluation of gene expression patterns, genomic sequence, or alternative splicing. Markers may be found using standard molecular biology and microarray analysis techniques as described in Sambrook Molecular Cloning a Laboratory Manual 2001 and Baldi, P., and Hatfield, W. G., DNA Microarrays and Gene Expression 2002.

Microarray analysis generally begins with extracting and purifying nucleic acid from a biological sample, (e.g. a biopsy or fine needle aspirate) using methods known to the art. For expression and alternative splicing analysis it may be advantageous to extract and/or purify RNA from DNA. It may further be advantageous to extract and/or purify mRNA from other forms of RNA such as tRNA and rRNA. In some embodiments, RNA samples with RIN≦5.0 are typically not used for multi-gene microarray analysis, and may instead be used only for single-gene RT-PCR and/or TaqMan assays. Microarray, RT-PCR and TaqMan assays are standard molecular techniques well known in the relevant art. TaqMan probe-based assays are widely used in real-time PCR including gene expression assays, DNA quantification and SNP genotyping.

Various kits can be used for the amplification of nucleic acid and probe generation of the subject methods. Examples of kit that can be used in the present invention include but are not limited to Nugen WT-Ovation FFPE kit, cDNA amplification kit with Nugen Exon Module and Frag/Label module. The NuGEN WT-Ovation™ FFPE System V2 is a whole transcriptome amplification system that enables conducting global gene expression analysis on the vast archives of small and degraded RNA derived from FFPE samples. The system is comprised of reagents and a protocol required for amplification of as little as 50 ng of total FFPE RNA. The protocol can be used for qPCR, sample archiving, fragmentation, and labeling. The amplified cDNA can be fragmented and labeled in less than two hours for GeneChip® 3′ expression array analysis using NuGEN's FL-Ovation™ cDNA Biotin Module V2. For analysis using Affymetrix GeneChip® Exon and Gene ST arrays, the amplified cDNA can be used with the WT-Ovation Exon Module, then fragmented and labeled using the FL-Ovation™ cDNA Biotin Module V2. For analysis on Agilent arrays, the amplified cDNA can be fragmented and labeled using NuGEN's FL-Ovation™ cDNA Fluorescent Module. More information on Nugen WT-Ovation FFPE kit can be obtained at www.nugeninc.com/nugen/index.cfm/products/amplification-systems/wt-ovation-ffpe/.

In some embodiments, Ambion WT-expression kit can be used. Ambion WT-expression kit allows amplification of total RNA directly without a separate ribosomal RNA (rRNA) depletion step. With the Ambion® WT Expression Kit, samples as small as 50 ng of total RNA can be analyzed on Affymetrix® GeneChip® Human, Mouse, and Rat Exon and Gene 1.0 ST Arrays. In addition to the lower input RNA requirement and high concordance between the Affymetrix® method and TaqMan® real-time PCR data, the Ambion® WT Expression Kit provides a significant increase in sensitivity. For example, a greater number of probe sets detected above background can be obtained at the exon level with the Ambion® WT Expression Kit as a result of an increased signal-to-noise ratio. Ambion WT-expression kit may be used in combination with additional Affymetrix labeling kit.

In some embodiments, AmpTec Trinucleotide Nano mRNA Amplification kit (6299-A15) can be used in the subject methods. The ExpressArt® TRinucleotide mRNA amplification Nano kit is suitable for a wide range, from 1 ng to 700 ng of input total RNA. According to the amount of input total RNA and the required yields of aRNA, it can be used for 1-round (input >300 ng total RNA) or 2-rounds (minimal input amount 1 ng total RNA), with aRNA yields in the range of >10 μg. AmpTec's proprietary TRinucleotide priming technology results in preferential amplification of mRNAs (independent of the universal eukaryotic 3′-poly(A)-sequence), combined with selection against rRNAs. More information on AmpTec Trinucleotide Nano mRNA Amplification kit can be obtained at www.amp-tec.com/products.htm. This kit can be used in combination with cDNA conversion kit and Affymetrix labeling kit.

In some embodiments, gene expression levels can be obtained or measured in an individual without first obtaining a sample. For example, gene expression levels may be determined in vivo, that is in the individual. Methods for determining gene expression levels in vivo are known to the art and include imaging techniques such as CAT, MRI; NMR; PET; and optical, fluorescence, or biophotonic imaging of protein or RNA levels using antibodies or molecular beacons. Such methods are described in US 2008/0044824, US 2008/0131892, herein incorporated by reference. Additional methods for in vivo molecular profiling are contemplated to be within the scope of the present invention.

Alternative Splicing Profile

Disclosed herein are methods of “fingerprinting” a sample using expression data from the sample, such as mRNA levels. Such methods are useful, e.g., to identify a sample as from a particular individual or to identify a sample as belonging or not belonging to a larger group of samples, e.g., for identifying and/or resolving sample mix-ups that can occur during collection, transport, processing, or analysis of a plurality of biological samples each belong to a subject of a plurality of subjects, wherein the gene expression data of the biological samples are obtained, wherein the alternative splicing profile of each of the biological samples are established by calculating the alternative splicing index (ASI) of each gene of each of the biological samples, and the sample mix-ups can be identified by relating the alternative splicing profile of each of the biological samples with other biological samples. The biomarkers or gene expression products are analyzed alternatively or additionally for characteristics other than expression level. In some embodiments, gene expression can be analyzed for alternative splicing. Alternative splicing, also referred to as alternative exon usage, is the RNA splicing variation mechanism wherein the exons of a primary gene transcript, the pre-mRNA, are separated and reconnected (e.g., spliced) so as to produce alternative mRNA molecules from the same gene. In some cases, these linear combinations then undergo the process of translation where a specific and unique sequence of amino acids is specified by each of the alternative mRNA molecules from the same gene resulting in protein isoforms.

A method is disclosed herein that can use existing gene expression data to look at alternative splicing events per exon, while simultaneously minimizing the weight of gene regulation-driven expression, thus reducing noise that would obscure a unique or highly individual signature consistent for a given individual, useful in, e.g., further identifying sample mix-ups. Multiple probesets belonging to the same exon within a given transcript for a gene can be grouped and analyzed together in order to calculate an Alternative Splicing Index (ASI). In some embodiments, alternative splicing profile is a collection of alternative splicing index of multiple genes in a biological sample or a subject. A profile may be created using ASIs for any suitable number of genes, such as 1-1000, 5-1000, 10-1000, 50-1000, 100-1000, 1-500, 5-500, 10-500, 20-500, 50-500, 100-500, 1-200, 5-200, 10-200, 20-200, 50-200, 1-100, 5-100, 10-100, 20-100, 30-100, 40-100, or 50-100 genes. In some cases 50-80 genes are used. Alternative splicing patterns or profiles can be dominated by multiple factors, including tissue specific factors, as well as disease specific variation. Similarly, alternative splicing pattern or profile of a gene can vary in magnitude among individuals. It is contemplated that if phenotypic variations in alternative splicing pattern or profile were determined by the presence of germline mutations as opposed to gene regulation-driven variation, distinct ASI clusters corresponding to a particular individual's genetic make-up are seen.

Disclosed herein are methods of obtaining mRNA profiles that are highly identified with a given individual, i.e., a “fingerprint,” useful in, e.g., dentifying and/or resolving sample mix-ups by relating the alternative splicing profile of each of one of more genes of each of a plurality of biological samples with the other alternative splicing profiles of other biological samples in the plurality of biological samples. Alternative splicing of a gene can include, for example, incorporating different exons or different sets of exons, retaining certain introns, or utilizing alternate splice donor and acceptor sites. In some embodiments, one or more genes meets at least one requirement selected from the group consisting of: a gene that contains a plurality of exons, a gene with an expression level that has a signal strength that is above a threshold value, and a gene that corresponds to exons that have a multimodal distribution of expression, or combination thereof.

In some embodiments, a gene that contains a plurality of exons is selected; for example, a gene can contain at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147 or 148 exons. The average number of exons in human is about 8. In some embodiments, a gene that contains at least 2 exons is selected. In some embodiments, a gene that contains at least 3 exons is selected. In some embodiments, a gene that contains at least 4 exons is selected. In some embodiments, a gene that contains at least 5 exons is selected. In some embodiments, a gene that contains at least 6 exons is selected. In some embodiments, a gene that contains at least 7 exons is selected. In some embodiments, a gene that contains at least 8 exons is selected. A preferred number of exons is 6. A gene can contain 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149 or 150 introns. An exon of a gene can contain a sequence length of less than 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 350, 400, 450, 500, 550, 600, 650, 700, 750, 800, 850, 900, 950, 1000, 1500, 2000, 2500, 3000, 3500, 4000, 4500, 5000, 5500, 6000, 6500, 7000, 7500, 8000, 8500, 9000, 9500, 10000, 10500, 11000, 11500 or 12000 bp. An intron of a gene can contain a sequence length of less than 5, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, 1000, 1500, 2000, 2500, 3000, 3500, 4000, 4500, 5000, 5500, 6000, 6500, 7000, 7500, 8000, 8500, 9000, 9500, 10000, 15000, 20000, 25000, 30000, 35000, 40000, 45000, 50000, 55000, 60000, 65000, 70000, 75000, 80000, 85000, 90000, 100000, 150000, 200000, 250000, 300000, 350000, 400000, 450000 or 500000 bp. The average number of introns in human is about 6.

In some embodiments, a gene that corresponds to exons shown to have a bimodal or multimodal distribution of ASI or gene expression is selected. Hence, the set of alternatively spliced events with those attributed to genetic/sample identity (e.g., due to inherited germline mutations that dictate alternative splicing) can be enriched. This approach can allow the exclusion of non-informative exons thereby enriching the contribution of informative exons, specific to the sample cohort under examination. In some embodiments, the multimodal distribution of expression is determined using Hartigan's dip test of unimodality. The dip test measures multimodality in a biological sample by the maximum difference over all sample points, wherein the maximum difference is calculated between the empirical distribution function, and the unimodal distribution function that minimizes the maximum difference. The uniform distribution is the asymptotically least favorable unimodal distribution, and the distribution of the test statistic is determined asymptotically and empirically when sampling from the uniform. The cut off set of the Hartigan's dip test of unimodality can be 0, 0.00001, 0.00005, 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 or 0.99. In certain embodiments a cut off of 0.05 is used. In certain embodiments, a cut off of 0.1 is used. In certain embodiments, a cut off of 0.01 is used.

In some embodiments, a gene with an expression level that has a signal strength that is above a threshold value is selected. The threshold value can be 0, 1, 2, 3, 4, 5, 6, 7, 8, 9, 10, 11, 12, 13, 14, 15, 16, 17, 18, 19 or 20 in log₂ units of intensity or space. In certain embodiments, a threshold value of 5 is used. In certain embodiments, a threshold value of 6 is used. In certain embodiments, a threshold value of 7 is used.

Any one or more of exon number, threshold for unimodality/multimodality, and/or expression level may be chosen to select genes for inclusion in a ASI and/or ASP. For example, all three may be used, e.g., at least 6 exons, a Hartigan's dip test cut off of 0.05, and a threshold value for signal strength of at least 6 in log₂ space.

In some cases, markers or sets of markers can be identified that exhibit alternative splicing that is diagnostic for benign, malignant or normal samples. Additionally, alternative splicing markers can further provide an identifier for a specific type of thyroid cancer (e.g. papillary, follicular, medullary, or anaplastic). Alternative splicing markers diagnostic for malignancy known in the art include those listed in U.S. Pat. No. 6,436,642, which is hereby incorporated by reference in its entirety.

The alternative splicing profile can be established by calculating the alternative splicing index (ASI) or splicing index (SI) of a gene. Existing annotations to probesets known to target alternative splicing sites can be retrieved from the Affymetrix NetAffx Analysis Center. The alternative splicing index can be calculated using the formula:

log(e_{i,j,k})−log(g_{j,k})=α_{i,k}+ε_{i,j,k}

### Where:

e_{i,j,k}=exon signal for i^{th} probeset, k tissue, j gene
g_{j,k}=transcript signal for k tissue and j gene
α_{i,k}=log coupling for exon and gene signals.
ε_{i,j,k}=error term
The ASI can thus be estimated as the observed difference log(e_{i,j,k})−log(g_{j,k}).

The data for each sample can be analyzed using feature selection techniques including filter techniques which assess the relevance of features by looking at the intrinsic properties of the data, wrapper methods which embed the model hypothesis within a feature subset search, and embedded techniques in which the search for an optimal set of features is built into a classifier algorithm. Filter techniques useful in the methods of the present invention include (1) parametric methods such as the use of two sample t-tests, ANOVA analyses, Bayesian frameworks, and Gamma distribution models (2) model free methods such as the use of Wilcoxon rank sum tests, between-within class sum of squares tests, rank products methods, random permutation methods, or TNoM which involves setting a threshold point for fold-change differences in expression between two datasets and then detecting the threshold point in each gene that minimizes the number of missclassifications (3) and multivariate methods such as bivariate methods, correlation based feature selection methods (CFS), minimum redundancy maximum relevance methods (MRMR), Markov blanket filter methods, and uncorrelated shrunken centroid methods. Wrapper methods useful in the methods of the present invention include sequential search methods, genetic algorithms, and estimation of distribution algorithms. Embedded methods useful in the methods of the present invention include random forest algorithms, weight vector of support vector machine algorithms, and weights of logistic regression algorithms. Bioinformatics. 2007 Oct. 1; 23(19):2507-17 provides an overview of the relative merits of the filter techniques provided above for the analysis of intensity data.

Identifying Samples as Mixed-Up

Within-Group and without-Group Cohorts

As an example of the uses of the methods disclosed herein are methods of identifying and/or resolving sample mix-ups that can occur during collection, transport, processing, or analysis of a plurality of biological samples by relating the alternative splicing profiles of the biological samples. The alternative splicing profiles can be related by performing a correlation analysis. The biological samples can be obtained from at least about two or more subjects. For each sample within the plurality of samples, a within-group and without-group cohort can be defined. The within-group cohort for an individual biological sample can include all other biological samples in the cohort of biological samples that are labeled as being obtained from the same subject. The without-group cohort for the individual biological sample can include all the biological samples in the cohort of biological samples that are labeled as being obtained from a different subject.

Subsequent to defining the within-group cohort and the outside-group cohort for each of the plurality of biological samples, a median within-group correlation score and a maximum outside-group correlation score can be calculated. The median within-group correlation score (e.g. average within-group correlation score, average within-group correlation coefficient, median within-group correlation coefficient) for each of the plurality of biological samples is calculated for the alternative splicing profile of each of the biological samples that in the within-group cohort. The median within-group correlation score can be calculated using any appropriate method, as known in the art. Known methods include an algorithm, using a statistic computer program, following a correlation coefficient formula, following Pearson's correlation coefficient formula, or following the algorithm described in Ferrari et al., “An approach to estimate between- and within-group correlation coefficients in multicenter studies . . . ,” Am J Epidemiol. 2005 Sep. 15; 162(6):591-8. The median within-group correlation score can be calculated on a computer, on a plurality of computers, on a calculator, on a plurality of calculators, over a network, or by hand.

The maximum outside-group correlation score (e.g. maximum outside-group correlation coefficient, maximum between group correlation coefficient, maximum between group correlation score) for each of the plurality of biological samples is calculated for the alternative splicing profile of each of the biological samples in the outside-group cohort. The maximum outside-group correlation score can be calculated using any appropriate method, as known in the art. Known methods include an algorithm, using a statistic computer program, following a correlation coefficient formula, following Pearson's correlation coefficient formula, or following the algorithm described in Ferrari et al., “An approach to estimate between- and within-group correlation coefficients in multicenter studies . . . ,” Am J Epidemiol. 2005 Sep. 15; 162(6):591-8. The maximum outside-group correlation score can be calculated on a computer, on a plurality of computers, on a calculator, on a plurality of calculators, over a network, or by hand.

The correlation analysis can be performed by comparing the median within-group correlation score and the maximum outside-group correlation score for each of the plurality of biological samples. The median within-group correlation score may be greater than 0.99, 0.98, 0.97, 0.96, 0.95, 0.94, 0.93, 0.92, 0.91, 0.90, 0.89, 0.88, 0.87, 0.86, 0.85, 0.84, 0.83, 0.82, 0.81, 0.80, 0.79, 0.78, 0.77, 0.76, 0.75, 0.74, 0.73, 0.72, 0.71, or 0.70 for the majority of the samples. In preferred embodiments, the median within-group correlation score may be greater than 0.92. The majority of the samples can be 99.9%, 99.8%, 99.7%, 99.6%, 99.5%, 99.4%, 99.3%, 99.2%, 99.1%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61% or 60%. The value of the median within-group correlation score establishes the upper boundary for the maximum outside-group correlation score that can be expected if no sample mix ups have occurred. Any instance in which the maximum outside-group correlation is higher in value than the median within-group correlation can indicate that a sample mix-up has occurred. It will be appreciated that, more generally, the method allows for the determination of whether one or more samples in a group of samples is from the same individual as the rest of the group or a different individual.

For all of the embodiments herein, it will be understood that the expression data that is used in the methods or compositions of the invention may have been gathered as part of an assay or analysis that is not necessarily related to producing the fingerprint of a sample, as described herein. For example, the data may have been collected as part of a an analysis aimed at diagnosis of a particular condition, for example cancer, e.g., thyroid cancer. Such methods are described in, e.g., US Patent Publication No. US 2011-0312520 A1. (Ser. No. 13/105,756), incorporated herein by reference in its entirety. The present methods and compositions provide, e.g., a method for determining whether, in the course of the assay or analysis, there has been one or more sample mix-ups. In some embodiments, the data may be gathered mainly solely for the purposes of providing a mRNA “fingerprint” of a sample, e.g, for forensic or other analysis where it is wished to determine if a particular sample in a group of samples is from the same individual as the other samples in the group.

The correlation analysis can be performed on a computer or on a plurality of computers. The correlation analysis can be performed using a computer software for statistical analysis. The correlation analysis can be performed over a network. The correlation analysis can be performed using a calculator or a plurality of calculators. The correlation analysis can be calculated by hand. The alternative splicing profile can be related by performing a correlation analysis. The alternative splicing profile can be related on a computer or on a plurality of computers. The alternative splicing profile can be related using a computer software for statistical analysis. The alternative splicing profile can be related over a network. The alternative splicing profile can be related using a calculator or a plurality of calculators. The alternative splicing profile can be related by hand. The correlation analysis can be performed single blinded or double blinded. The alternative splicing profile can be related single blinded or double blinded.

The invention also provides compositions. For example, the invention provides a machine-readable medium in a tangible physical form that is either portable or associated with a computer, on which one or more computer-executable instructions are contained for performing an analysis to relate a biological sample to a plurality of biological samples, where the biological sample is related to the plurality of biological sample using an alternative splicing profile of the biological sample and each of the plurality of biological samples.

### Resolving Sample Mix-Ups

Exemplary embodiments of the methods disclosed herein include methods of identifying and/or resolving sample mix-ups that can occur during collection, transport, processing, or analysis of a plurality of biological. Upon identifying the sample mix-ups, a strategy of resolving sample mix-ups can be executed. In some embodiments, sample mix-ups can be resolved by measuring again the gene expression of the samples that are mixed up. Sample mix-ups can also be resolved by replacing the samples that are mixed up to their correct locations or swapping the samples that are mixed up so that they are returned to the correct groups or subjects. In some embodiments, a set of gene expression data with sample mix-ups can also be resolved by discarding the data of the samples that are mixed-up, or by placing the data of the mixed-up samples into the appropriate groups, e.g., for data re-analysis after the mix-up is resolved.

### EXAMPLES

### Example A

### Alternative Splicing Index Using mRNA Gene Expression Data and Its Use as a Sample Mix-Up Indicator

### Methods

Data generated from a cohort of human thyroid fine needle aspirates (FNA) using the Affymetrix GeneChip Human Exon 1.0 ST Array was used. The cohort consisted of samples from 19 patients (1-7 samples per patient, 68 samples total, Table 1). This clinical cohort was originally designed to investigate the differences in gene expression observed in thyroid nodule FNAs (pre-op FNA) compared to FNAs from adjacent normal tissue. All samples were collected in vivo during surgery, prior to surgical excision, while patients were under general anesthesia with their thyroids exposed and clearly visible. The nodules from a subset of patients also underwent multiple FNA sampling of the same nodule to investigate the variability of gene expression within each nodule (intra-nodule FNAs A, B, C, D, or E).

Existing annotations to probesets known to target alternative splicing sites were retrieved from the Affymetrix NetAffx Analysis Center. The alternative splicing index can be modeled using the formula:

log(e_{i,j,k})−log(g_{j,k})=α_{i,k}+ε_{i,j,k}

### Where:

e_{i,j,k}=exon signal for i^{th} probeset, k tissue, j gene
g_{j,k}=transcript signal for k tissue and j gene
α_{i,k}=log coupling for exon and gene signals.
ε_{i,j,k}=error term
The ASI can thus be estimated as the observed difference log(e_{i,j,k})−log(g_{j,k}).

TABLE 1
Thyroid FNA sample cohort.

| | Intra-Nodule FNA | | | | | | | |
|---|---|---|---|---|---|---|---|---|
| | | | | | | | Adjacent- | Per Patient |
| | | | | | | Pre-op | Normal | Sample |
| Patient ID | A | B | C | D | E | FNA | FNA | Total |
| 191 | 1 | 1 | 1 | 1 | 1 | 1 | 1 | 7 |
| 331 | 1 | 1* | 1 | 1 | 1 | 1 | 1 | 7 |
| 131 | 1 | 1 | 1 | 1 | 1 | 1 | | 6 |
| 271 | | 1 | 1 | 1 | 1* | 1 | 1 | 6 |
| 421 | 1 | 1 | 1 | 1 | 1 | 1 | | 6 |
| 431 | 1 | 1 | 1 | 1 | 1 | 1 | | 6 |
| 051 | 1 | 1 | 1 | 1 | 1 | | | 5 |
| 141 | 1 | | 1 | 1 | 1 | 1 | | 5 |
| 181 | | 1 | 1 | 1 | 1 | | | 4 |
| 171 | | | | | | 1 | 1 | 2 |
| 221 | | | | | | 1 | 1 | 2 |
| 231 | | | | | | 1 | 1* | 2 |
| 281 | | | | | | 1 | 1 | 2 |
| 301 | | | | | | 1 | 1 | 2 |
| 381 | | | | | | 1 | 1 | 2 |
| 201 | | | | | | 1 | | 1 |
| 311 | | | | | | 1 | | 1 |
| 321 | | | | | | 1 | | 1 |
| 411 | | | | | | 1 | | 1 |
| Cohort | 7 | 8 | 9 | 9 | 9 | 17 | 9 | 68 |
| Total | | | | | | | | |

*denotes flagged as potential sample mix-up.

Briefly, probeset-transcript relationships were established for all probesets and robust multichip average (RMA) was run at both the probeset (exon) and transcript (gene) levels to summarize and normalize all data. Only transcripts containing 6 or more exons were evaluated, followed by filtering out probesets with low expression signals (≦6, log₂ space). Hartigan's dip test statistic⁶ was then used to test unimodality with the cut off set at >0.05. This approach resulted in the identification of 68 informative exons used to generate an alternative splicing signature/index. The alternative splicing index was then used to generate intra- and extra-group correlation analyses in order to rule-in or rule-out sample mix ups.

Results

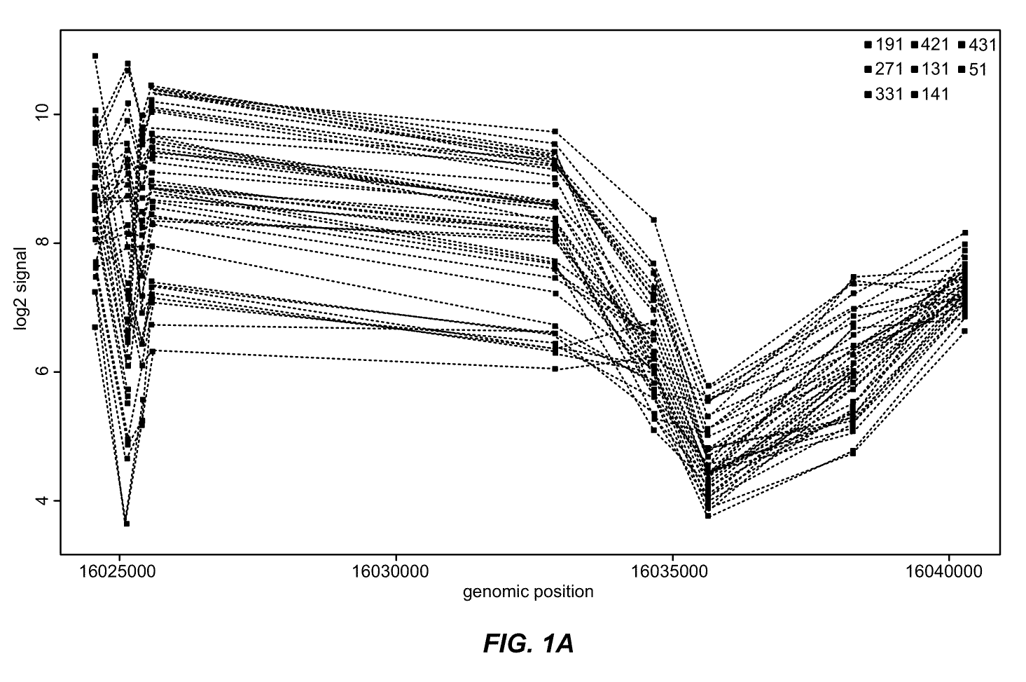

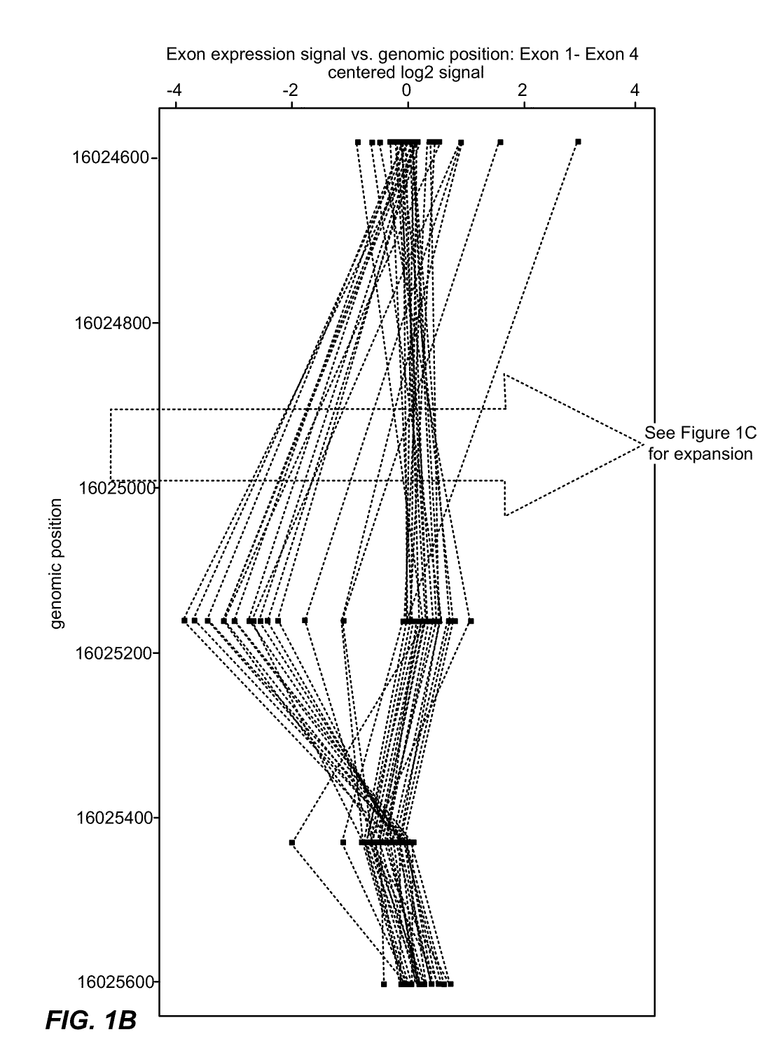

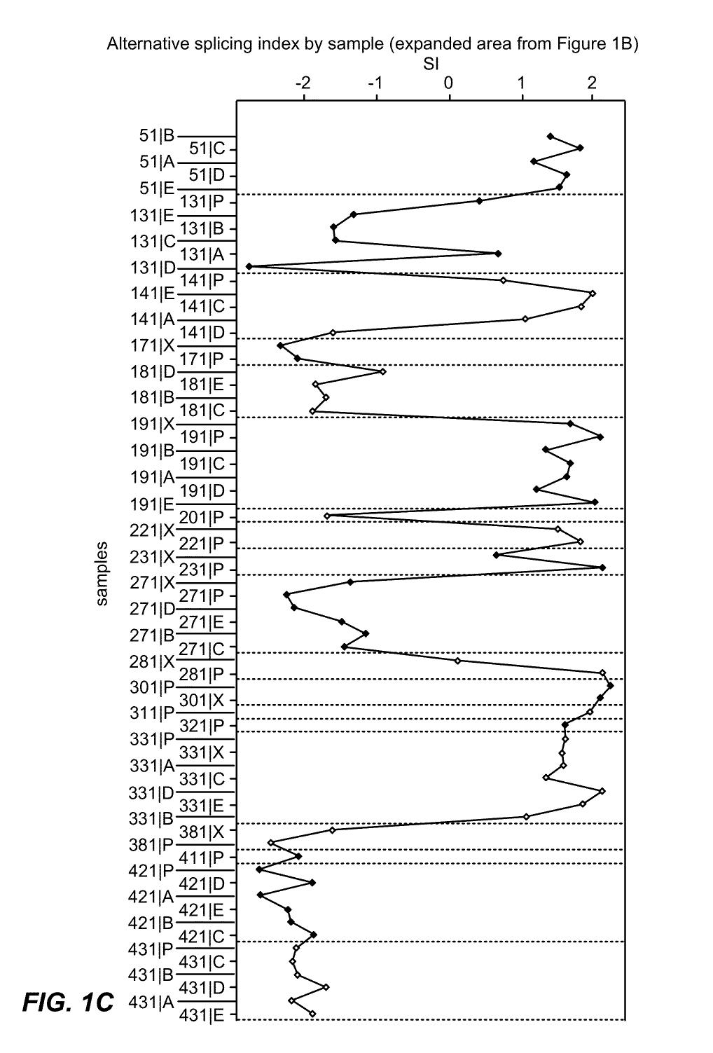

Calculation of an alternative splicing index (ASI) using mRNA gene expression data can facilitate the determination of genetic signatures from existing data, without the need to re-process samples. Inside the cell, alternative splicing can be controlled by numerous factors that vary in frequency and intensity among and within individuals. Inherited germline mutations are one factor that can determine some portion of observed alternative splicing events. These naturally occurring mutations can dictate the genomic site at which the transcript will be spliced. Existing knowledge of these alternative splicing sites was used to develop individual gene signatures for every sample within a cohort of samples. An example of a simple ASI calculated by examining exons in a single gene transcript is shown in FIG. 1. Exon 2 of gene CYP4F11 is expressed in roughly half of the samples examined (FIGS. 1A & 1B). Transformation of gene expression data using the methods disclosed herein can allow for the calculation of ASI's for this exon (FIG. 1C). While this example consists of a gene “signature” derived from only a single exon, one can notice that most groups of samples belonging to the same patient have similar ASI values. However, not all of the calculated ASI values from samples belonging to patients 131 and 141 are closely related, suggesting that a sample mix up may have occurred and that further analysis is needed. It was contemplated that an ASI derived by looking at multiple alternative spliced transcripts could be more robust than this single-transcript, proof-of-principle example.

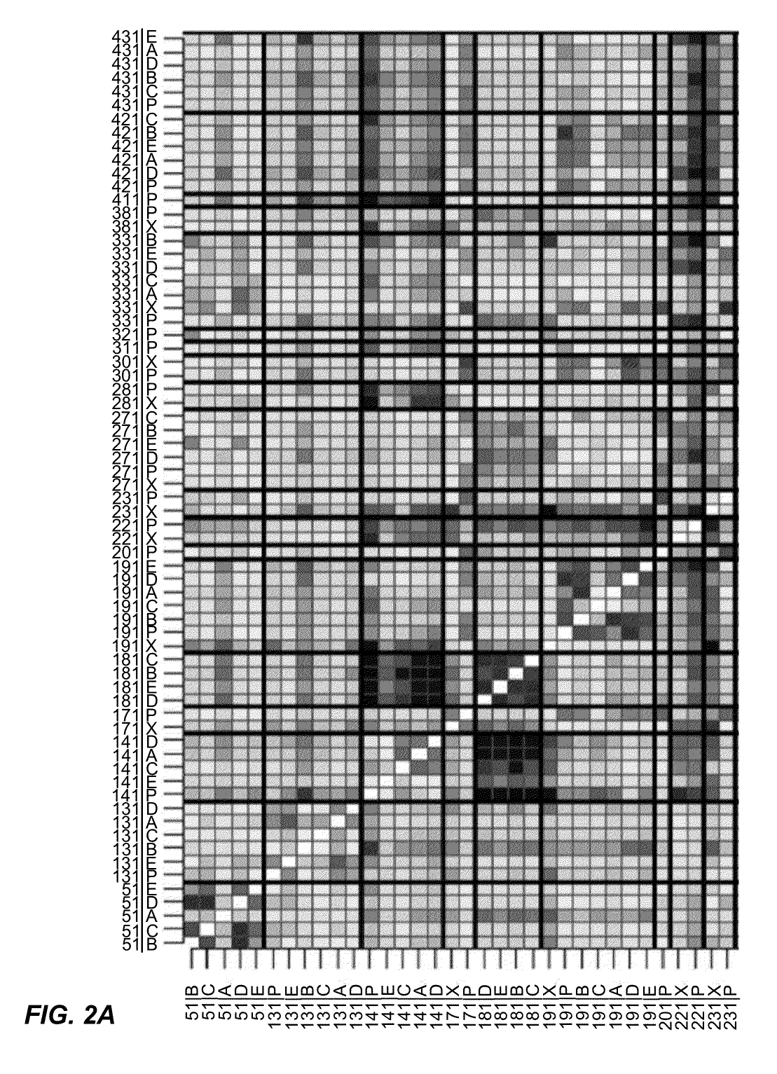

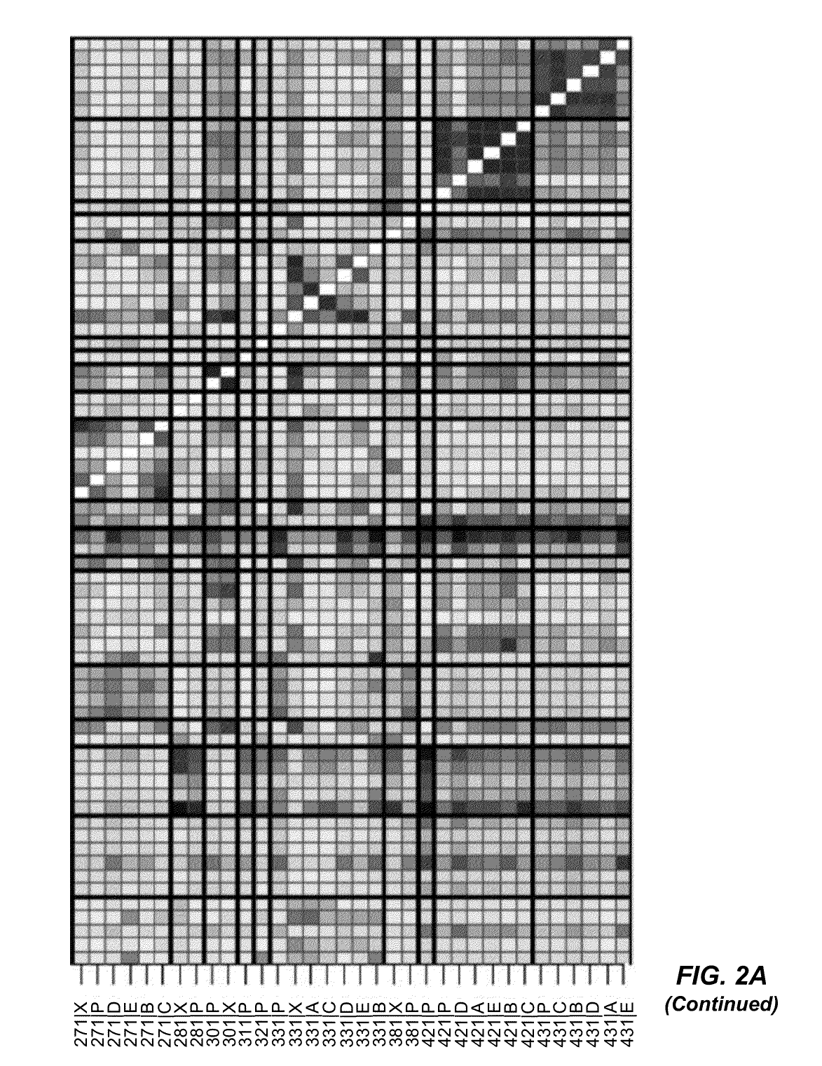

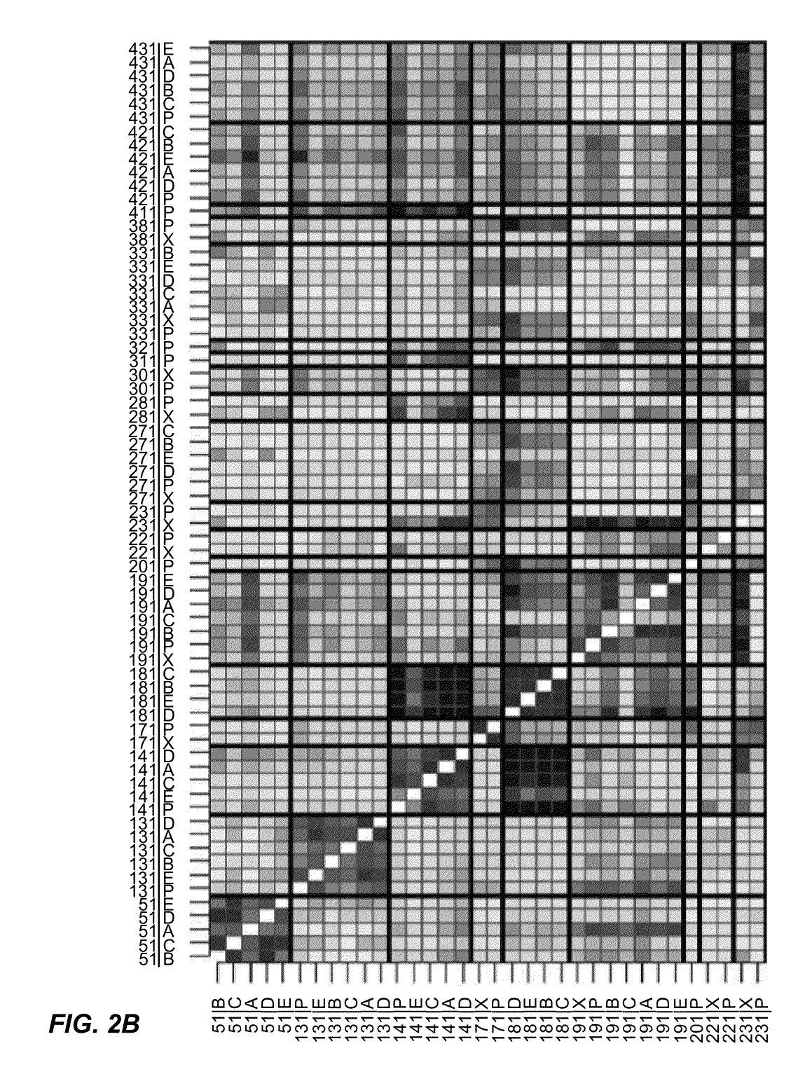

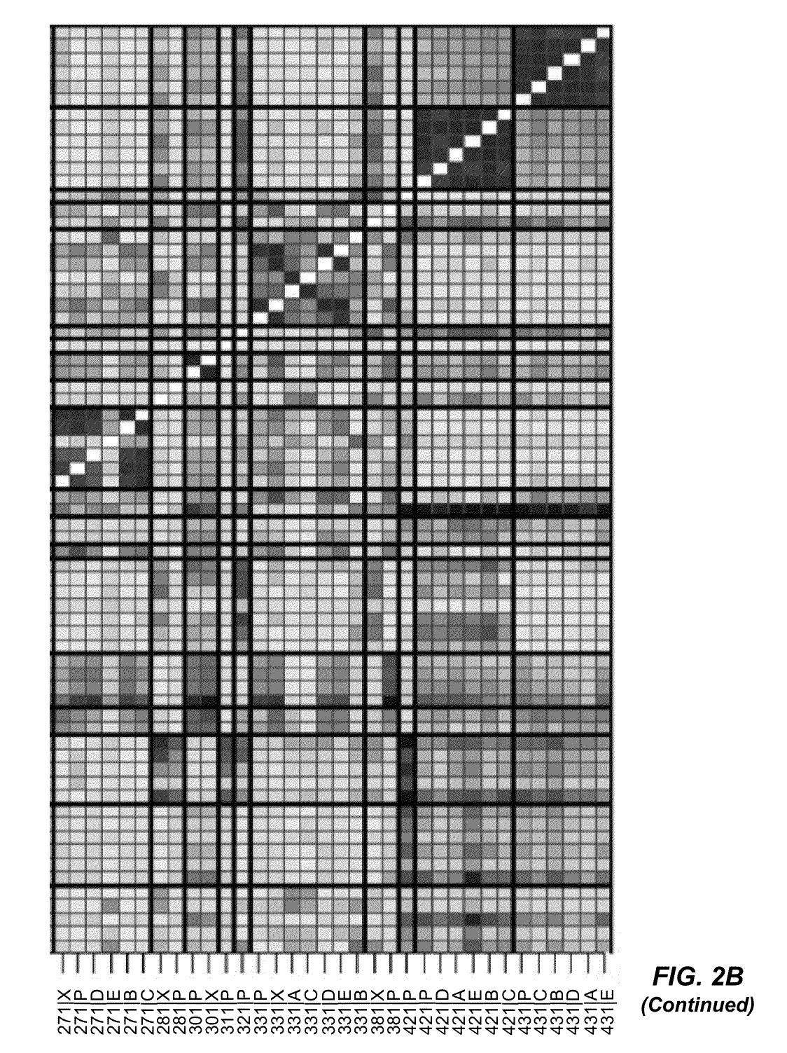

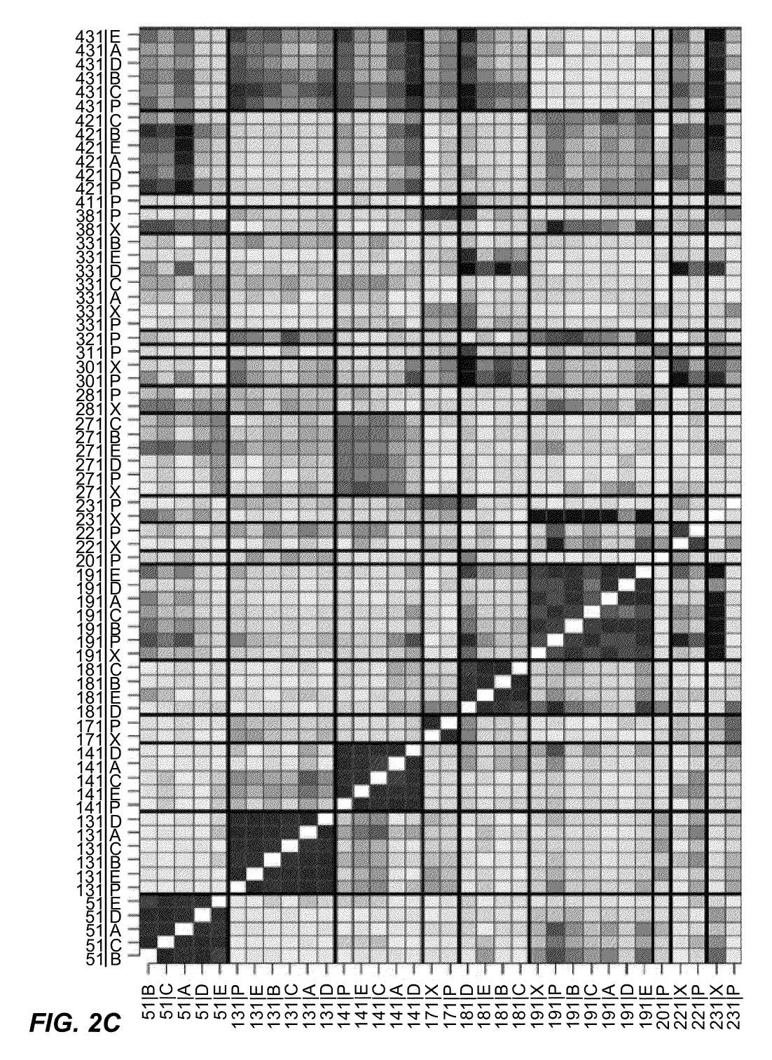

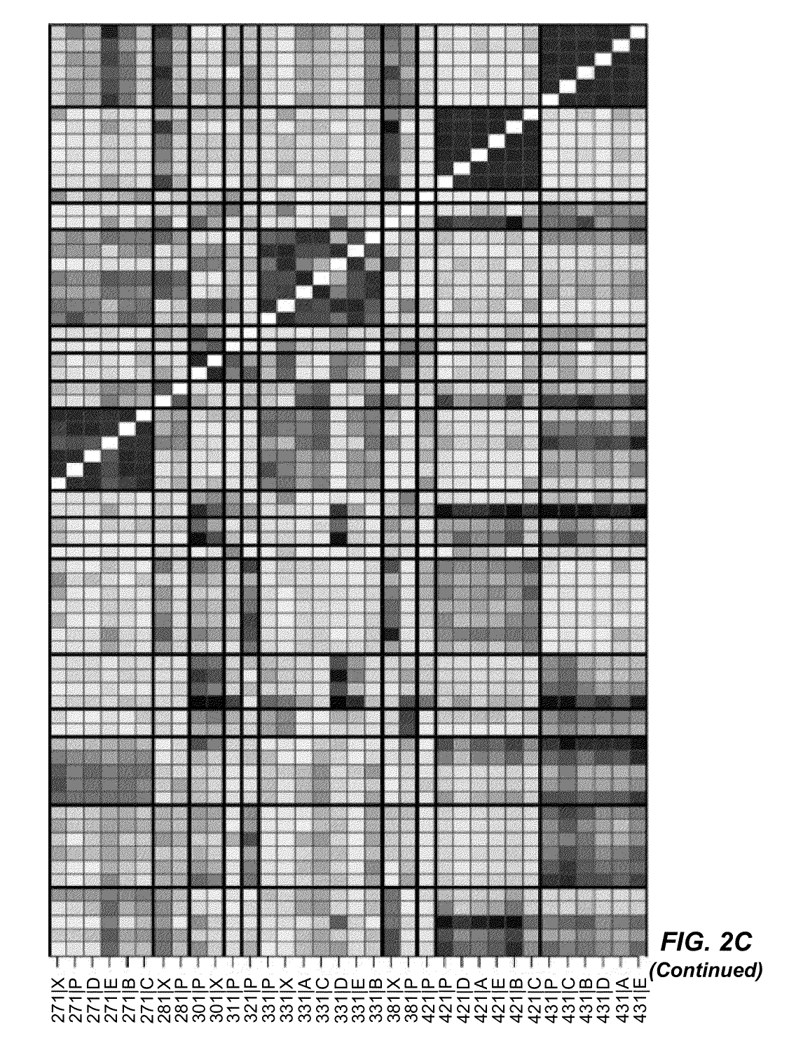

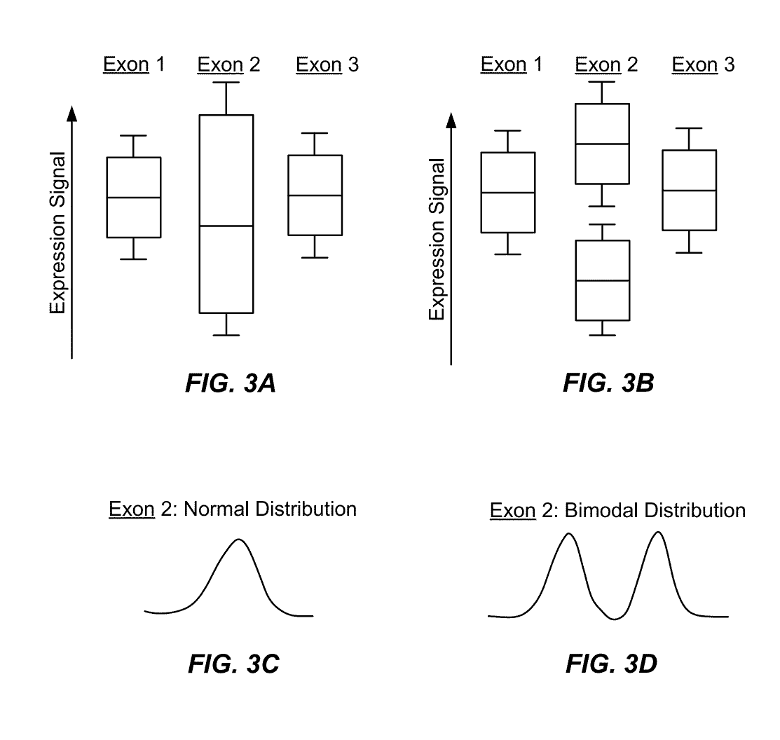

To improve on this initial assessment, the number of transcripts examined simultaneously in the ASI calculation was increased and a series of data filtering steps designed to boost robustness was added. FIGS. 2A, 2B and 2C are black-and-white representations of the tri-color heatmaps indicating the level of correlation. Briefly, FIG. 2 illustrates that with addition of more filtering steps are included, the correlation can be higher. Transcripts having 6 or more exons were selected and the correlation of the calculated ASI against that of all other samples was examined (FIG. 2A). This assessment showed promise, however correlations within samples belonging to the same patient can be less than optimal. Next, the data was filtered and only probesets that showed strong expression signals (>6, log₂ space) were selected (FIG. 2B). Since, many redundant and poorly understood biological mechanisms can lead to alternative splicing in a given tissue or subject, attention was focused on transcripts that showed multimodal distribution of expression signals in at least one exon (FIG. 2C). The rationale is that, although alternative splicing can occur due to a number of unknown variables, for some transcripts a constant variable lies in the presence of inherited germline mutations that can dictate alternative splicing¹. This effect can be observed when one examines the distribution of gene expression signals across a cohort of samples for a given exon (FIG. 3). Gene expression signals from many exons exhibit a normal (e.g., Gaussian) distribution, often with large variance. However, at a population level, certain genes can exhibit bimodal gene expression patterns²⁻⁴ and some of these are due to inherited germline mutations⁵. Hence, analysis was further focused on exons showing deviation from the unimodal gene expression and known to carry mutations that dictate alternative splicing, as these can untangle the data to establish a per sample gene signature using existing gene expression data.

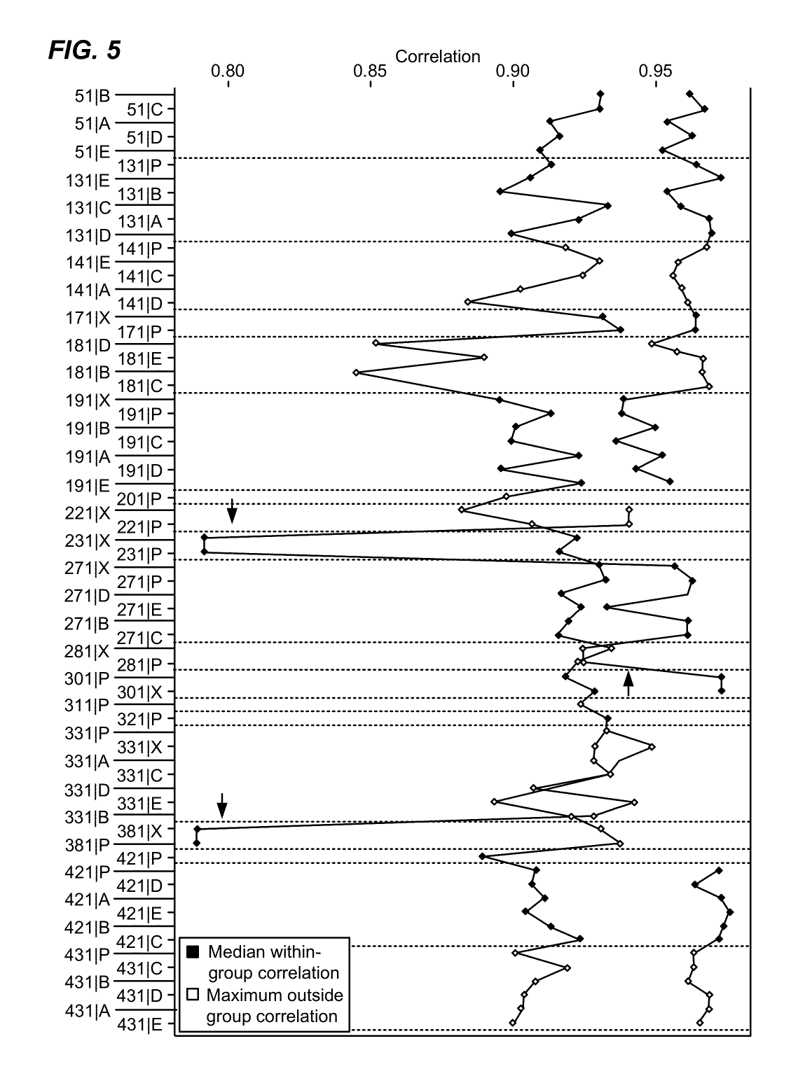

Unsupervised cluster analysis using ASI calculated from 68 distinct transcripts shows that most samples belonging to any one patient cluster together (FIG. 4). A rigorous assessment was performed by calculating median within-group, and maximum outside group correlations for all samples within the cohort (FIG. 5). These calculations reveal the utility of ASI as a tool to rule-in and rule-out sample mix ups. The median within-group correlation is >0.92 for the majority of the samples ( 66/68, 97%), and this value establishes the upper boundary for the maximum outside-group correlation that can be expected if no sample mix ups have occurred. Any instance in which the maximum outside-group correlation is higher in value than the median within-group correlation can indicate that a sample mix-up has occurred. These data imply that at least one sample from subjects 231, 281, and 381 respectively, was mixed up, as the median within-group correlation for these pairs of samples are much lower that their maximum outside-group correlation with the entire cohort. Conversely, these correlation analyses rule out sample mix up for samples 131 and 141, respectively (FIG. 1). The ASI calculated by examining 68 transcripts can be more robust than the ASI calculated from a single transcript.

The accuracy of the ASI method was validated by performing STR fingerprinting analysis on DNA samples that were isolated in parallel to their corresponding RNA (Table 2). Concordance between the RNA-based ASI method and the DNA STR method was 100%.

TABLE 2
Validation of ASI results using STR DNA fingerprinting analysis.

| | Sample | Within Subject RNA ASI | Within Subject STR |
|---|---|---|---|
| Subject ID | ID | Result | DNA Result |
| C1A051 | 051A | match | match |
| | 051B | match | match |
| | 051C | match | match |
| | 051D | match | match |
| | 051E | match | match |
| | 051P | match | match |
| C1A181 | 181B | match | match |
| | 181C | match | match |
| | 181D | match | match |
| | 181E | match | match |
| | 181P | match | match |
| C1A231 | 231P | unmatched | unmatched |
| | 231X | unmatched | unmatched |
| C1A281 | 281P | unmatched | unmatched |
| | 281X | unmatched | unmatched |
| C1A381 | 381P | unmatched | unmatched |
| | 381X | unmatched | unmatched |

### REFERENCES

1. Wessagowit V, Nalla V K, Rogan P K, McGrath J A. Normal and abnormal mechanisms of gene splicing and relevance to inherited skin diseases. J Dermatol Sci 2005 40:73-84.
2. Bessarabova M, Kirillov E, Shi W, Bugrim A, Nikolsky Y, Nikolskaya T. Bimodal gene expression patterns in cancer. BMC Genomics 2010 11:S8
3. Krawczak M, Reiss J, Cooper D N. The mutational spectrum of single base-pair substitutions in mRNA splice junctions of human genes: causes and consequences. Hum Genet 1992; 90:41-54.
4. Hellwig, B, Hengster J G, Schmidt M, Gehrmann M C, Schormann W, Rahnenfuhrer J. Comparison of scores for bimodality of gene expression distributions and genomic-wide evaluation of the prognostic relevance of high-scoring genes 2010 11:276.
5. Kristensen V N, Edvardsen H, Tsalenko A, Nordgard S H, Sørlie T, Sharan R, Vailaya A, Ben-Dor A, Lønning P E, Lien S, Omholt S, Syvänen A C, Yakhini Z, Børresen-Dale A L. Genetic variation in putative regulatory loci controlling gene expression in breast cancer. PNAS 2006 103:7735-40.
6. Hartigan J A and Hartigan P M. The Dip Test of Unimodality. Ann. Statist. Volume 13, Number 1 (1085), 70-84.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of establishing a sample mRNA signature, the method comprising:
a. assaying a biological sample to obtain a set of gene expression data for the biological sample;
b. determining an alternative splicing index (ASI) for a gene in the set of gene expression data; and
c. establishing an alternative splicing profile for the sample using the alternative splicing index, thereby establishing the sample mRNA signature of the biological sample.

2. The method of claim 1, wherein the set of gene expression data contains expression data for at least two genes and the ASI is determined using the data for the at least two genes.

3. The method of claim 1, wherein the biological sample is assayed by microarray, serial analysis of gene expression (SAGE), blotting, RT-PCR, sequencing, or quantitative PCR.

4. The method of claim 1, wherein the ASI is calculated using the equation:
log(e_{i,j,k})−log(g_{j,k}),
wherein e_{i,j,k} equals an exon signal for i^{th} probeset, k tissue, j gene; and g_{j,k} equals a transcript signal for k tissue and j gene.

5. The method of claim 2, wherein each of the at least two genes comprises a plurality of exons.

6. The method of claim 2 wherein each of the at least two genes comprises at least three exons.

7. The method of claim 2 wherein each of the at least two genes comprises at least six exons.

8. The method of claim 2 or 5, wherein each of the at least two genes is a gene with an expression level that has a signal strength that is above a threshold value.

9. The method of claim 8 wherein the threshold value is 6 in log 2 units of intensity.

10. The method of claim 2, 5 or 8 wherein each of the at least two genes is a gene that corresponds to exons that have a multimodal distribution of expression.

11. The method of claim 10 wherein the multimodal distribution of expression is determined using Hartigan's dip test of unimodality with a cut off set at greater than 0.05.

12. A method of relating a biological sample to a plurality of biological samples, wherein the plurality of biological samples are obtained from a subject, the method comprising:
a. establishing an alternative splicing profile using a set of gene expression data for the biological sample and each of the plurality of biological samples;
b. relating the alternative splicing profiles of the biological sample and the plurality of biological samples using a computer; and
c. identifying whether the biological sample is from the same subject of the plurality of biological samples.

13. The method of claim 12, wherein the set of gene expression data contains expression data of one or more genes.

14. The method of claim 12, wherein the alternative splicing profile is related by performing a correlation analysis.

15. The method of claim 12, wherein the biological sample is assayed by microarray, serial analysis of gene expression (SAGE), blotting, RT-PCR, sequencing, or quantitative PCR.

16. The method of claim 12, wherein the ASI is calculated using the equation:
log(ei,j,k)−log(gj,k),
wherein ei,j,k equals an exon signal for ith probeset, k tissue, j gene; gj,k equals a transcript signal for k tissue and j gene.

17. The method of claim 13, wherein each of the one or more genes meets at least one requirement selected from the group consisting of:
a gene that contains a plurality of exons,
a gene with an expression level that has a signal strength that is above a threshold value, and
a gene that corresponds to exons that have a multimodal distribution of expression.

18. The method of claim 12 wherein the sample is identified as from the same subject as the plurality of samples.

19. The method of claim 18 wherein the sample is identified as not from the same subject as the plurality of biological samples.

20. The method of claim 19 wherein the sample and the plurality of samples belong to a pool of samples, and the sample that has been identified as not from the same subject as the plurality of samples is removed from the pool of samples.

21. The method of claim 12, wherein the alternative splicing profile is established by calculating the alternative splicing index (ASI) of each of the one or more genes.

22. The method of claim 14, the correlation analysis is performed by:
a. defining for each of the plurality of biological samples a within-group cohort and an outside-group cohort, wherein the within-group cohort contains all of the plurality of biological samples that belong to the same subject, and wherein the outside-group cohort contains all of the plurality of biological samples that belong to a different subject;
b. subsequent to defining the within-group cohort for each of the plurality of biological samples, producing a median within-group correlation score for each of the plurality of biological samples, wherein the median within-group correlation score is calculated using the alternative splicing profile of each of the biological samples that in the within-group cohort;
c. subsequent to defining the outside-group cohort for each of the plurality of biological samples, producing a maximum outside-group correlation score for each of the plurality of biological samples, wherein the maximum outside-group correlation score is calculated using the alternative splicing profile of each of the biological samples in the outside-group cohort; and
d. comparing the median within-group correlation score and the maximum outside-group correlation score for each of the plurality of biological samples, thereby performing correlation analysis.

23. The method of claim 12, wherein the plurality of biological samples are from thyroid tissue.

24. A machine-readable medium in a tangible physical form that is either portable or associated with a computer, on which one or more computer-executable instructions are contained for performing an analysis to relate a biological sample to a plurality of biological samples, wherein the biological sample is related to the plurality of biological sample using an alternative splicing profile of the biological sample and each of the plurality of biological samples.
